(19) United States
(12) Patent Application Publication
(10) Pub. No.: US 2024/0257292 A1
(43) Pub. Date: Aug. 1, 2024

(54) System, Devices, and Methods Including RGB (Red, Green, Blue) Bit Central Processing Units, RGB Bit Memory Circuitry, and RGB Bit Logic Computation

(71) Applicant: Magnetic Spectrum Institute LLC, Norcross, GA (US)

(72) Inventors: Josh Tyler TOMS, Norcross, GA (US); John Franklin DEPEW, Norcross, GA (US); Doranne Baker SATTERLEE, Norcross, GA (US)

(73) Assignee: Magnetic Spectrum Institute LLC, Norcross, GA (US)

(21) Appl. No.: 18/235,684

(22) Filed: Aug. 18, 2023

Related U.S. Application Data
(60) Provisional application No. 63/371,809, filed on Aug. 18, 2022.

(51) Int. Cl. G06T 1/20; G06N 10/20; G06T 1/60; G09G 3/32

(52) U.S. Cl. CPC G06T 1/20; G06N 10/20; G06T 1/60; G09G 3/32

(57) ABSTRACT

A system is provided that includes processing circuitry configured to store a predetermined mapping of separate pieces of bit information and data symbols in a first format, each piece of bit information defining a bit and including (i) at least a color that is based one or more of at least two different colors or (ii) at least one of a plurality of magnetic states; and receive data symbols in the first format and output bits based on the stored predetermined mapping.

### CROSS-REFERENCE TO RELATED APPLICATIONS

This application claims the benefit of priority under 35 USC § 119(e) of U.S. Provisional Patent Application No. 63/371,809 filed Aug. 18, 2022, the contents of which are incorporated herein by reference in its entirety.

### BACKGROUND

### Field

The disclosure herein generally relates to methods and systems for mapping separate pieces of bit information based on at least a color that is based one or more of at least two different colors or at least one of a plurality of magnetic or vibrational states.

### Related Art

Quantum computation harnesses the collective properties of quantum states, including superposition, interference, and entanglement to perform calculations. Conventional binary computer-based CPUs use transistors to perform calculations: on, off, one (1) and zero (0). With quantum computers, the processing and storage of 1's and 0's give way to qubits or quantum bits as the fundamental building block, a two-state quantum-mechanical system. The power of these qubits is their inherent ability to scale exponentially so that a two-qubit machine allows for four calculations simultaneously, a three-qubit machine allows for eight calculations and a four-qubit machine performs 16 simultaneous calculations. Quantum computers leverage this phenomenon to tackle complex problems that would take super computers long periods of time and physical space to solve. By adding temporal variation to a state, i.e., color patterning, alternating color patterning, alternating magnetic patterning, etc. a change of state can be realized creating more dynamic mathematical algorithms.

Quantum computers are extremely sensitive to noise and environmental effects. And information only remains quantum for so long. Also, the number of operations that can be performed before information is lost is limited. Quantum chips must be kept colder than outer space to create superposition and entanglement of qubits, and retention as long as possible. Communication with qubits that are inside a dilution refrigerator is accomplished by using calibrated microwave pulses so that the qubit is put into a superposition, or the qubit's state is flipped from 0 to 1 by applying a microwave pulse between two qubits. Microwave signals are also responsible for entanglement. When quantum computers provide an answer, it is the form of probability. When the question is repeated, the answer changes. The more times a question is repeated, the closer the response comes to a theoretical percentage or correct answer.

Therefore, what is needed is an improvement to conventional binary computer-based CPUs use transistors to perform calculations to meet the emerging demands of quantum computation environments.

### BRIEF SUMMARY

In an aspect, the present disclosure is directed to, among other things, RGB Bit Logic Computation systems, devices, and methods including an RGB (Red, Green, and Blue) Bit Generator, an RGB Bit Memory, and an RGB Bit Central Processing Unit (CPU) for protecting data exchanges while ensuring authenticity, confidentiality, and integrity of the data.

In an aspect, the present disclosure is directed to, among other things, a system including an RGB (Red, Green, and Blue) Bit Generator, an RGB Bit Memory, and an RGB Bit Central Processing Unit (CPU). In an embodiment, the RGB Bit Generator is configured to generate RGB Bit information. In an embodiment, the RGB Bit Memory circuitry is configured to store the RGB Bit information. In an embodiment, the RGB Bit Central Processing Unit (CPU) is operably coupled to the RGB Bit Memory circuitry and is configured to compute RGB Bit logic using any combination of RGB Bits, for example Blue, Green, and Red.

In an aspect, the present disclosure is directed to, among other things, a method including generating RGB (Red, Green, and Blue) Bit representation; detecting and storing the RGB Bit representation; and determining an input RGB logic state or an output RGB Bit logic state and a temporal variation to a state responsive to addressing the RGB Bit representation.

In an aspect, the present disclosure is directed to, among other things, an RGB (Red, Green, Blue) Bit Logic Computation System. In an embodiment, the RGB Bit Logic Computation System includes means for generating RGB Bit information. In an embodiment, the RGB Bit Logic Computation System includes a means for storing the RGB Bit information. In an embodiment, the RGB Bit Logic Computation System includes a means for computing using RGB Bit Logic.

In an aspect, the present disclosure is directed to, among other things, RGB Bit Logic Computation systems, devices, and methods that combination of the color spectrum and magnetics to create color magnetic spectrum states for computation. In an aspect, the present disclosure is directed to, among other things, RGB Bit Logic Computation systems, devices, and methods that leveraged “magnetic spectrum states.” In an embodiment a “magnetic spectrum state” refers to a unique state created by combining the colors and magnetism of the RGB Bit Logic Computation System.

### BRIEF DESCRIPTION OF THE DRAWINGS

The patent or application file contains at least one drawing executed in color. A more complete appreciation of the embodiments and many of the attendant advantages thereof will be readily obtained as the same becomes better understood by reference to the following detailed description when considered in connection with the accompanying drawings, wherein:

FIG. 1A is a schematic diagram of an RGB Bit Logic Computation System according to one embodiment.

FIG. 1B is a schematic diagram of an RGB Bit Logic Computation System prototype according to one embodiment.

FIG. 1C is a diagram illustrating how each color in an RGB Bit combination is generated over a period of time.

FIG. 1D is a diagram illustrating alternative embodiments to a color wheel used for generating RGB Bits.

FIG. 1E is a schematic diagram of an RGB Bit Hysteresis Loop representing the magnetic color spectrum according to one embodiment.

FIG. 1F is a schematic diagram of an RGB Bit Logic Table with logic gates according to one embodiment.

FIG. 1G is a schematic diagram of an RGB Bit Neural Network according to one embodiment.

FIG. 1H shows an example of how RGB Bits can be use to enhance a weighting system within a neural network.

FIG. 1I shows an example of how a neural network can be used to learn how to identify an RGB Bit based on inputted color values.

FIG. 1J shows an example of how a RGB Bits can be used to normalize inputs to a neural network.

FIG. 1K shows an example of how preprogrammed light enters an RGB Bit borescope and travels through a reflective chamber.

FIG. 1L is a schematic diagram of an RGB Bit borescope prototype with an RGB Bit subdivision reflective chamber and camera sensor according to one embodiment.

FIG. 1M is a schematic diagram reflecting the differences between binary and RGB Bit polarity states according to one embodiment. FIG. 1N is a schematic drawing showing an eye dropper function which can sample any colors of a memory address according to one embodiment.

FIG. 1-O is a schematic drawing showing signed RGB Bit polarity direction, most significant and least significant bit or any combination thereof according to one embodiment.

FIG. 2A is a schematic diagram for creating, transmitting, and receiving RGB Bit states using an RGB Bit opto-coupler according to one embodiment.

FIG. 2AA is a schematic diagram of an RGB Bit transducer impulse generator and receiver process according to one embodiment, demonstrating an oscillating full color spectrum and magnetic state.

FIG. 2B is a schematic diagram of an RGB Bit hexagonal packing data topology geometrical array of RGB Bit transmitters or receivers according to one embodiment.

FIG. 2C is a schematic diagram of an RGB Bit geometric sphere clock mapping synchronization of timing and spacing, and input, output signal clocking and counting according to one embodiment.

FIG. 2D is a schematic diagram of a conversion of the RGB Bit system to a typical ASCII system according to one embodiment.

FIG. 2E is a schematic diagram of RGB Bit data impulse clocking according to one embodiment.

FIG. 2F is a schematic drawing of a RGB alternating color logic polar coordinates vibrational logic rotating color or color phases as evidenced by RGB Bit temporal variables reflecting variations of existing states.

FIG. 2G reflects RGB Bit alternating color temporal variables showing inverting variables: oscillating magnetic color spectrum states.

FIG. 2H shows different perspectives of the features of FIGS. 2F and 2G in a 3D virtual environment.

FIG. 3A is a schematic diagram of an RGB Bit hysteresis memory magnetic core using a Hall effect sensor to distinguish a positive, negative, or neutral flux according to one embodiment.

FIG. 3B is a schematic diagram of RGB Bit memory locations in timing and spacing of RGB Bit memory showing a color RGB Bit QR code and predefined positions for RGB Bit storage of data: read, write, timing, and spacing according to one embodiment.

FIG. 3C is a schematic diagram representing RGB Bit superposition and entanglement according to one embodiment.

FIG. 3D represents spectral quantum RGB memory dots on a compact disk (CD) according to one embodiment.

FIG. 3E is a schematic diagram of an RGB Bit Processor CPU according to one embodiment.

FIG. 4A is a schematic diagram of an RGB Bit signal inverting topology according to one embodiment.

FIG. 4B shows the RGB Bit tensor vector space using color mathematical computations according to one embodiment.

FIG. 4C is a schematic diagram representing RGB Bit arithmetic logic according to one embodiment.

FIG. 4D is a schematic diagram representing RGB Bit radians hue saturation brightness according to one embodiment.

FIG. 5 is a flow diagram of an RGB Bit method according to one embodiment.

FIG. 6 is a flow diagram of an RGB Bit means according to one embodiment.

FIG. 7 is a flow diagram related to a method performed by the system depicted in FIG. 1A.

FIG. 8 is a flow diagram related to a method performed by the system features depicted in FIG. 2F.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein.

### DETAILED DESCRIPTION

In an embodiment, the RGB Bit system improves current limitations associated with entanglement and other current issues associated with quantum computing. Today's super conductivity composites are very difficult to make and control. In an embodiment, the RGB Bit processing system overcomes the limitations of traditional quantum computing as it is not limited by microwave pulsing or environmental factors like temperature and noisy environments. It provides greater stability and increased storage using color polarity.

Accordingly, in an embodiment, the present disclosure is directed to, among other things, systems, devices, and methods that leverage color spectrum and magnetism using RGB Bits to process and perform improvement in computer decision making mathematical algorithms while requiring less energy and providing greater stability. In an embodiment, the present disclosure is directed to, among other things, systems, devices, and methods that protect data exchanges while ensuring authenticity, confidentiality, and integrity of the data. In an embodiment, the disclosed technologies and methodologies include components, hardware, firmware, software, drivers, utilities, and the like operably coupled to enable computational based RGB Bit logic. In an embodiment, the present disclosure is directed to, among other things, systems, devices, and methods that distinguish one RGB Bit logic state from another RGB Bit logic state based on a detected magnetic polarity or rate of change between magnetic polarities. In an embodiment, the present disclosure is directed to, among other things, systems, devices, and methods that distinguish one RGB Bit logic state from another RGB Bit logic state based on a detected color or a detected rate of change between colors.

The RGB Bit Generator innovation generates, interprets and stores (fetch—gets the next program command from the computer's memory; decode—deciphers what the program is telling the computer to do; execute—carries out the requested action and saves the result to a register or memory—Arithmetic Logic Unit, store—the newly processed RGB Bit data is written back unto the memory location, i.e. RAM). The RGB Bit generator signals represent a more dynamic and complex format than traditional computing using the magnetic spectrum—colors and magnetic polarities combined into instruction cycles. It uses improved RGB Bit data systems to pioneer a better way of generating, processing and storing data over the traditional way of binary computing. Practical examples include a physical device that can now combine 3 bits of analog and/or digital binary data into 1 single color. The RGB Bit Generator is a signal generating and translating device. It can be trained to interpret color and polarity. The Magnetic Spectrum Intelligence—MSI—can be trained to interpret color and polarity for Artificial Intelligence (AI). The magnetic memory state becomes a bit point for RGB Bit data storage. It allows for direct data transfer from traditional magnetic processing. Traditional computing takes states and converts into a digital binary format. The RGB Bit Generator processes in the RGB Bit state and does not require another step for processing. It is a one-to-one conversion and eliminates the amount of wires required for computer operation. The RGB Bit Generator no longer requires a resistor which operates on heat. Magnetic states stay in the RGB Bit state, reducing heat and wiring requirements to get to that state, required in traditional computing. The RGB Bit Generator allows for greater storage. For example, with FPGA (Field Programmable Gate Array) logic cells, a quantum dot can be placed on any geometric form and interpreted with light, vibration, magnetic signature, etc. For example, an RGB Bit Generator can be built with RGB or any variation for AI, interpreting color and expected output. It is estimated that interaction magnetically can significantly increase efficiency.

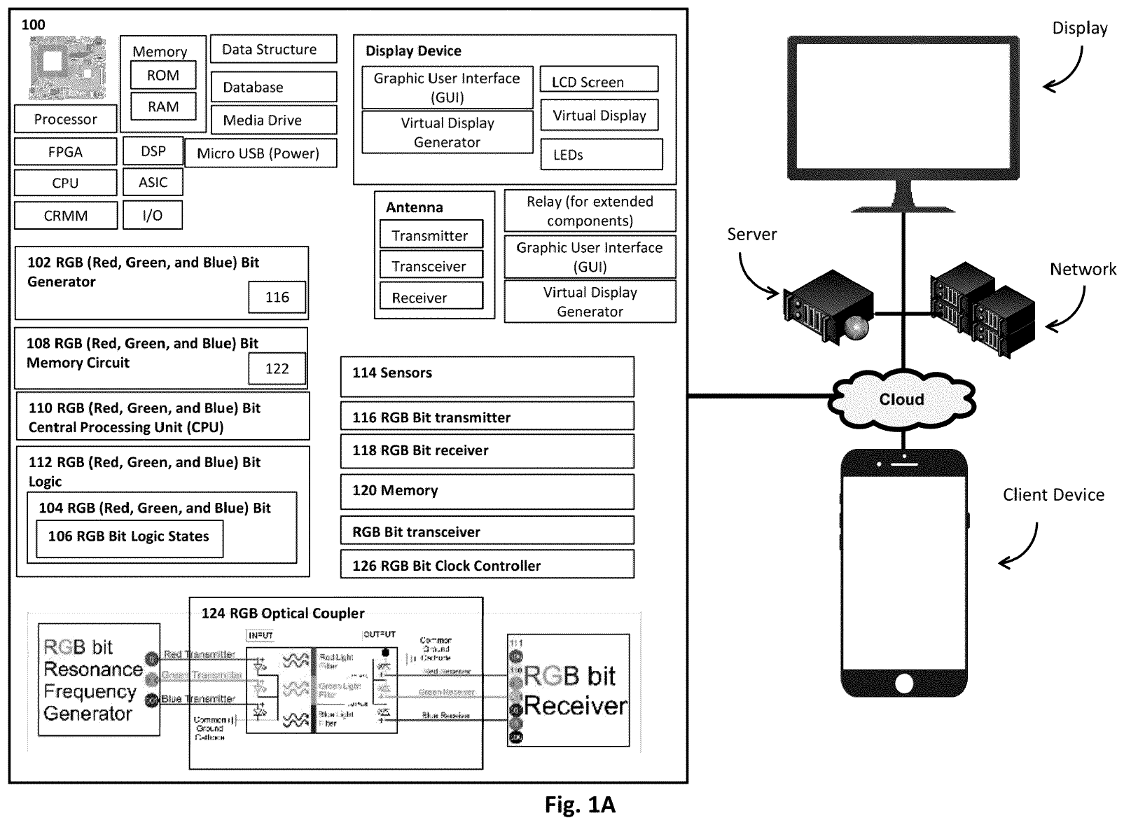

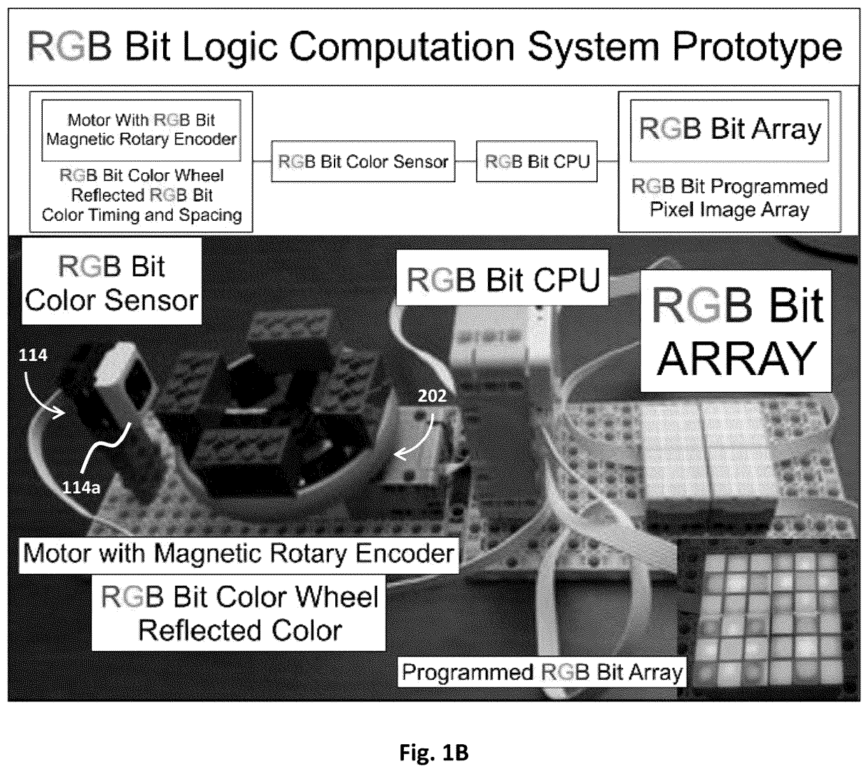

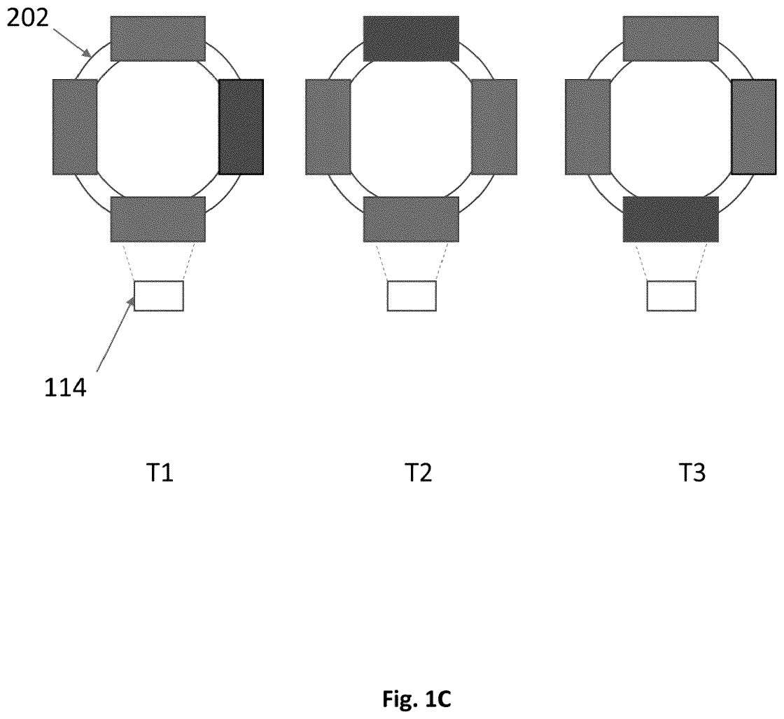

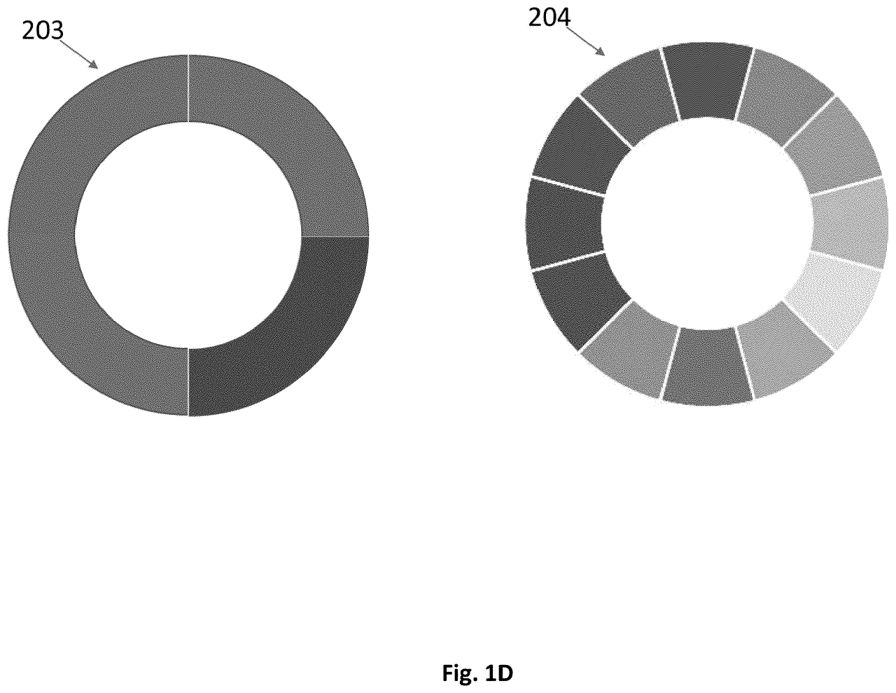

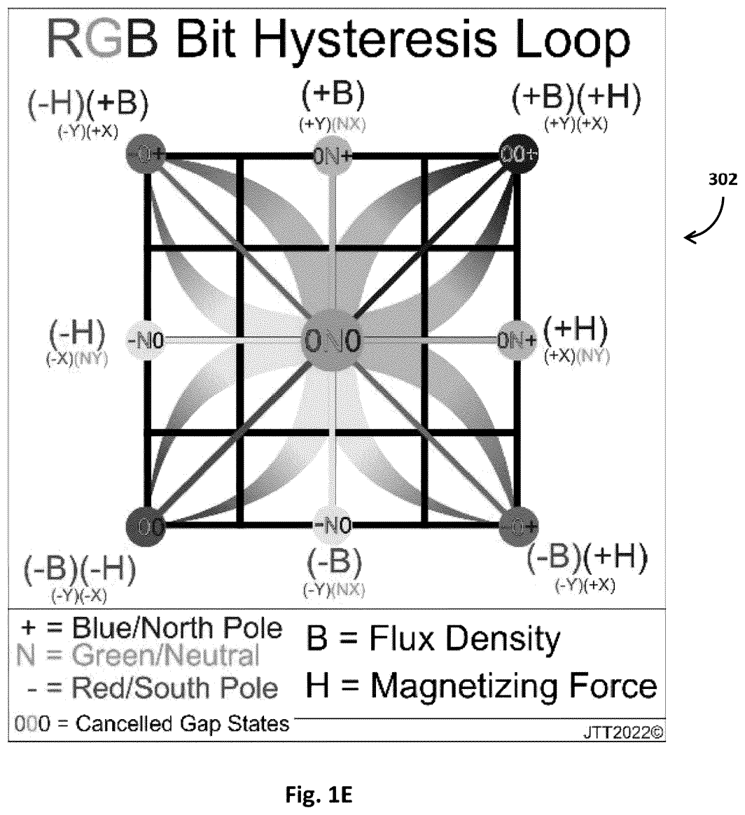

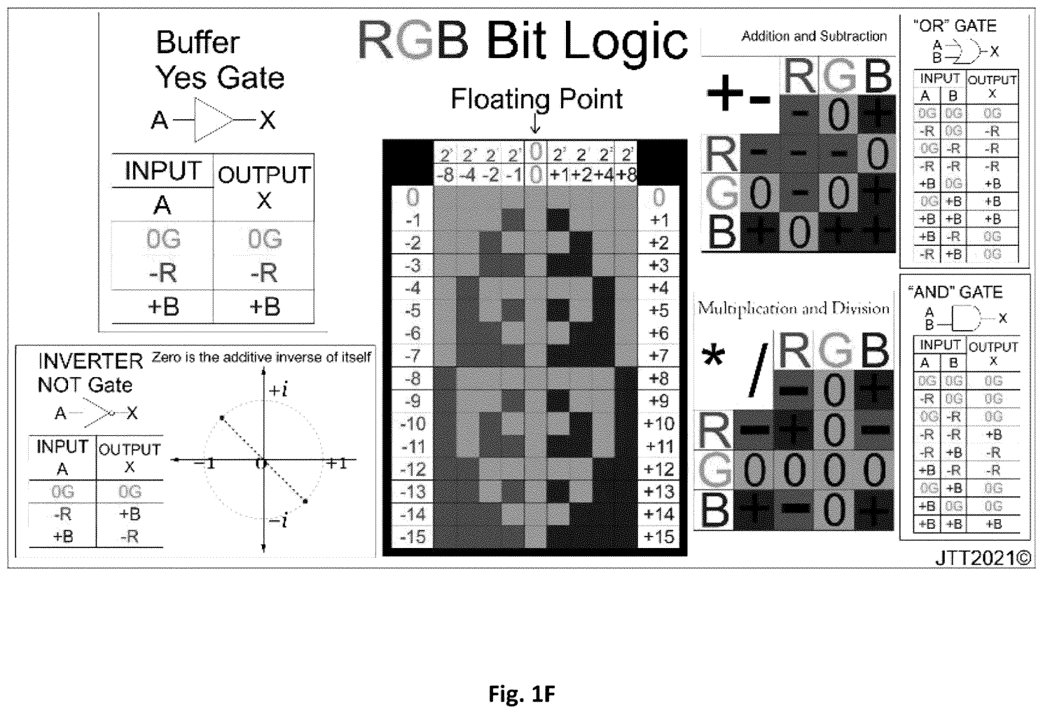

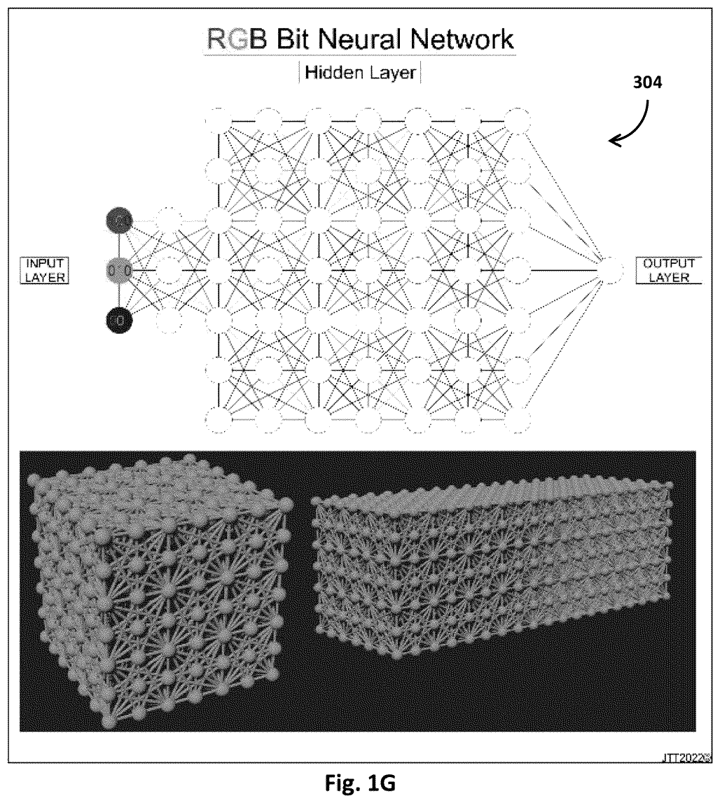

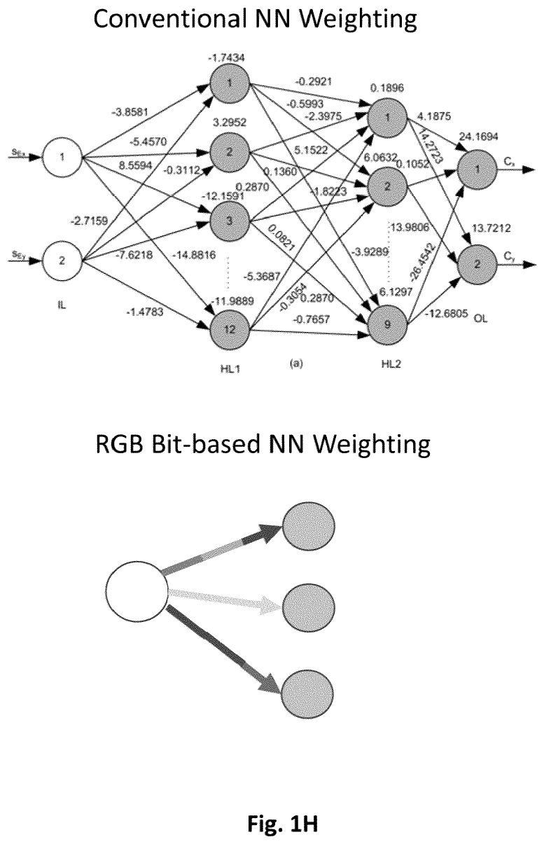

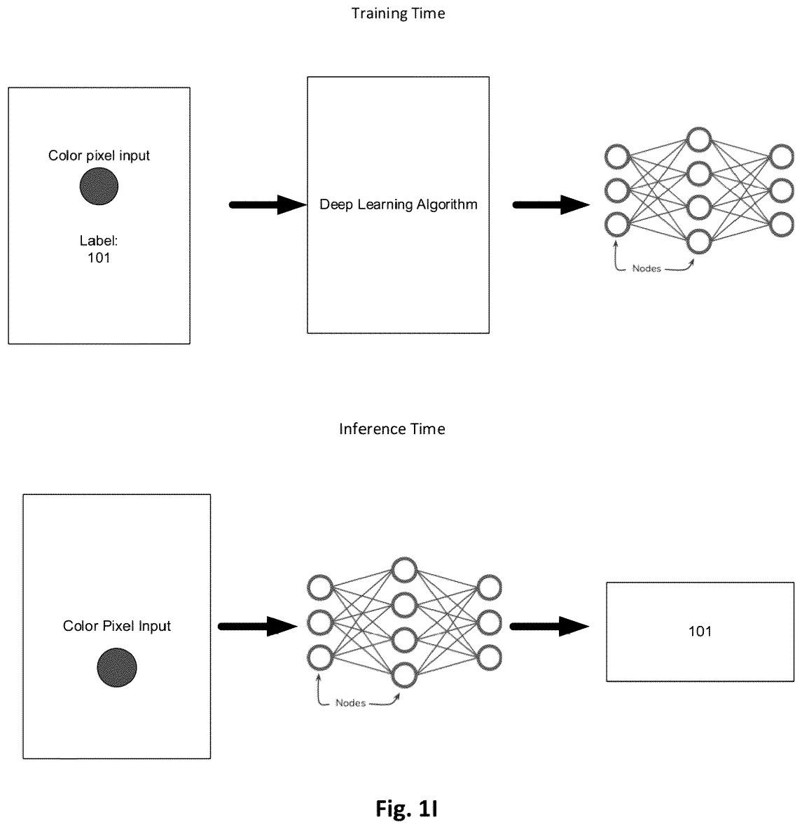

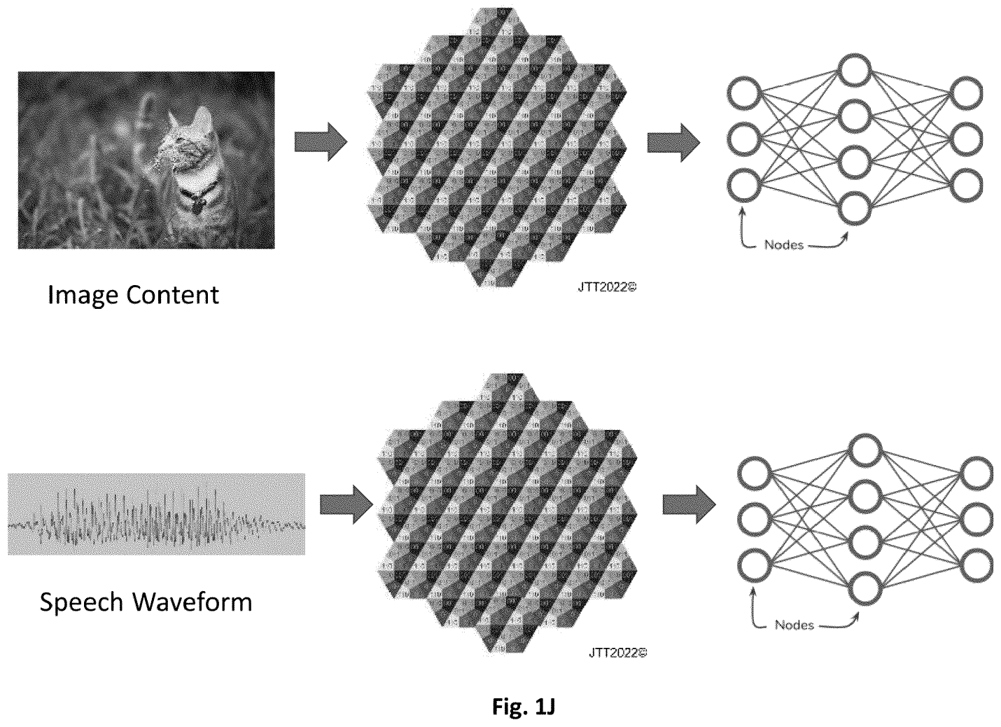

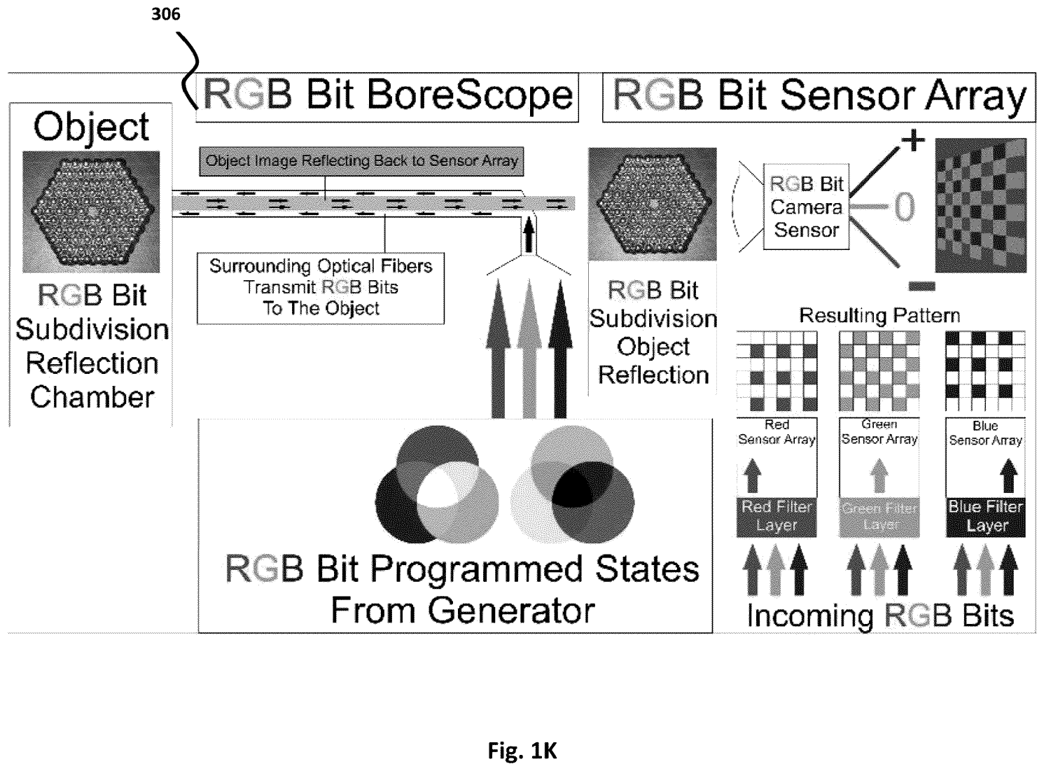

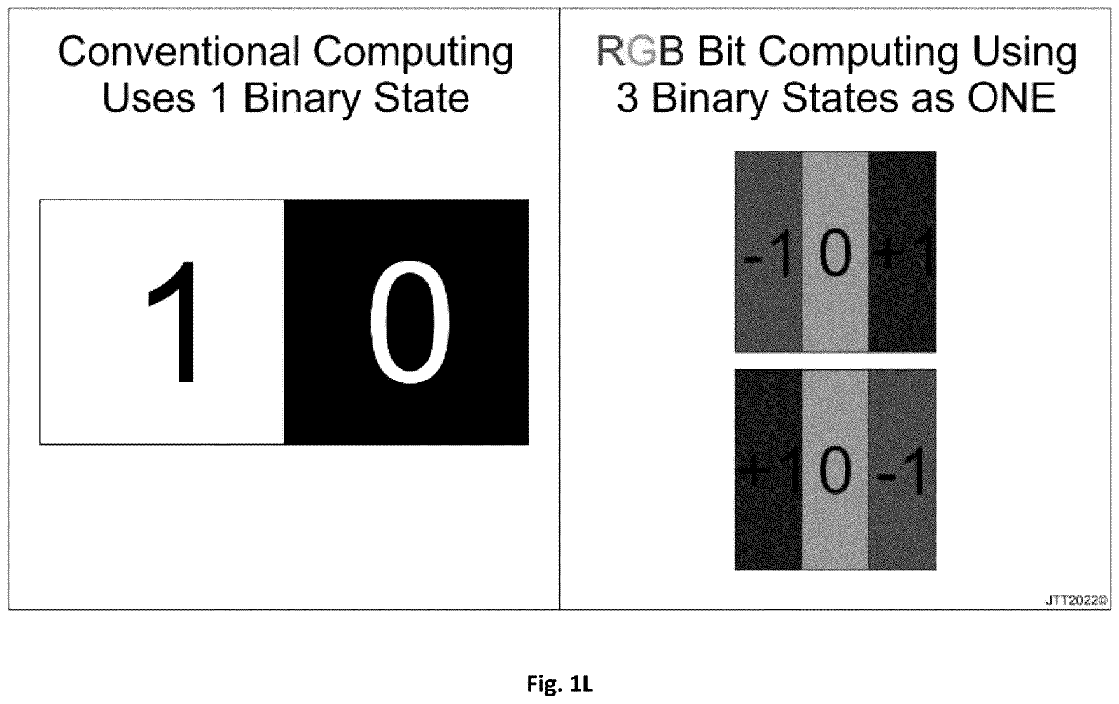

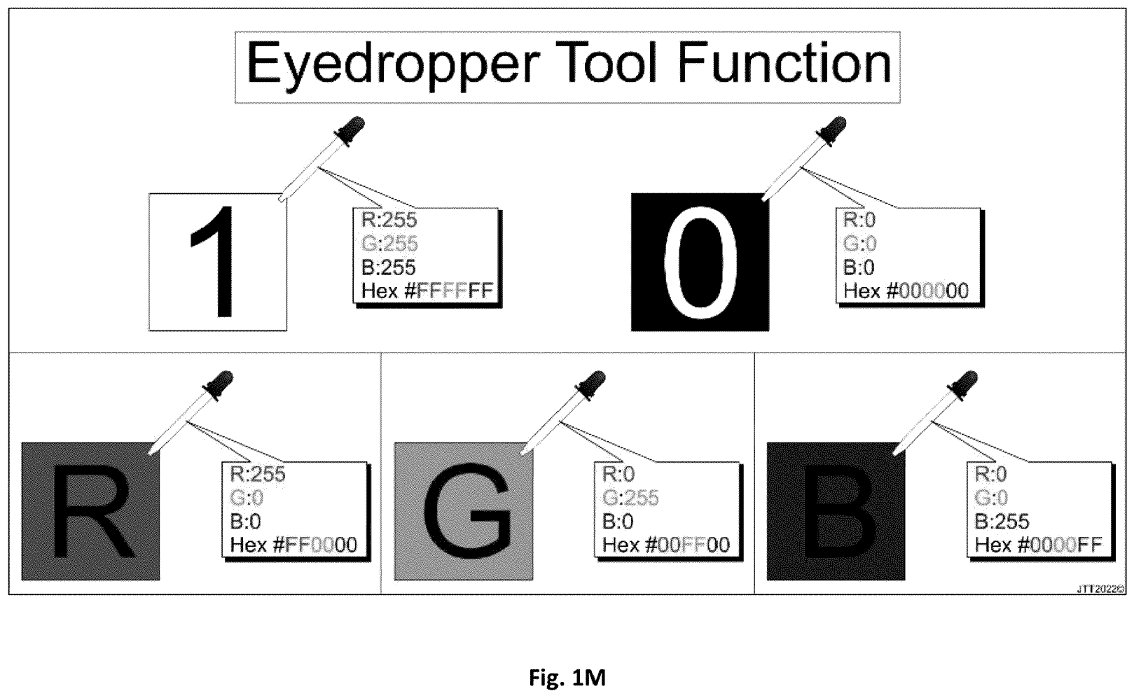

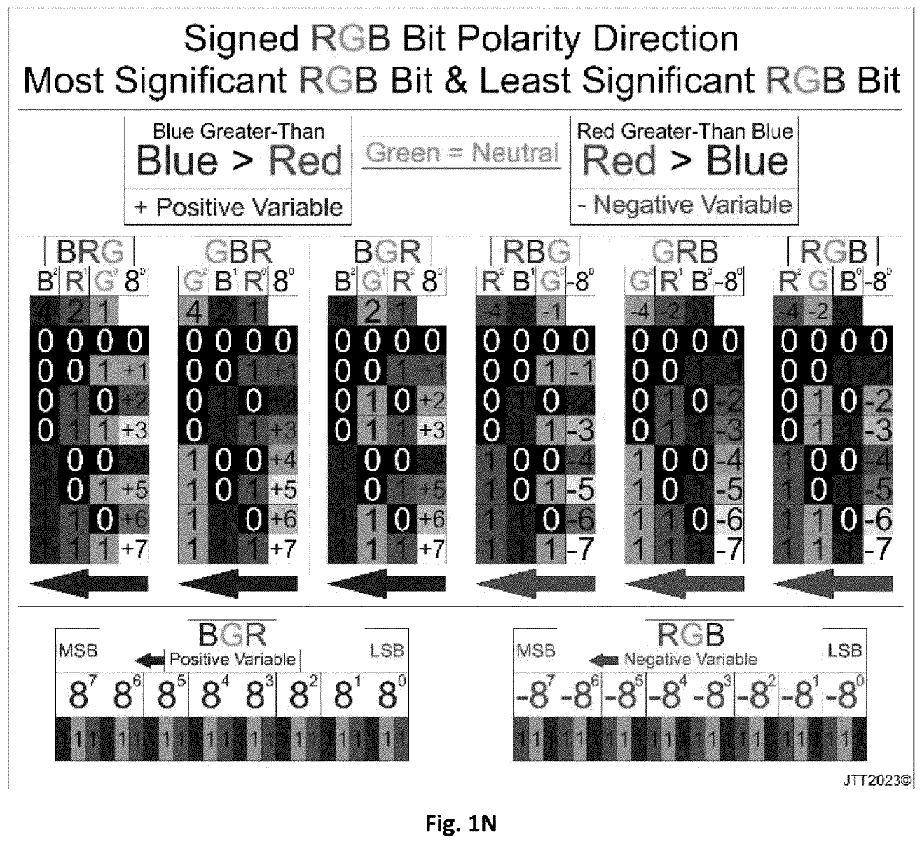

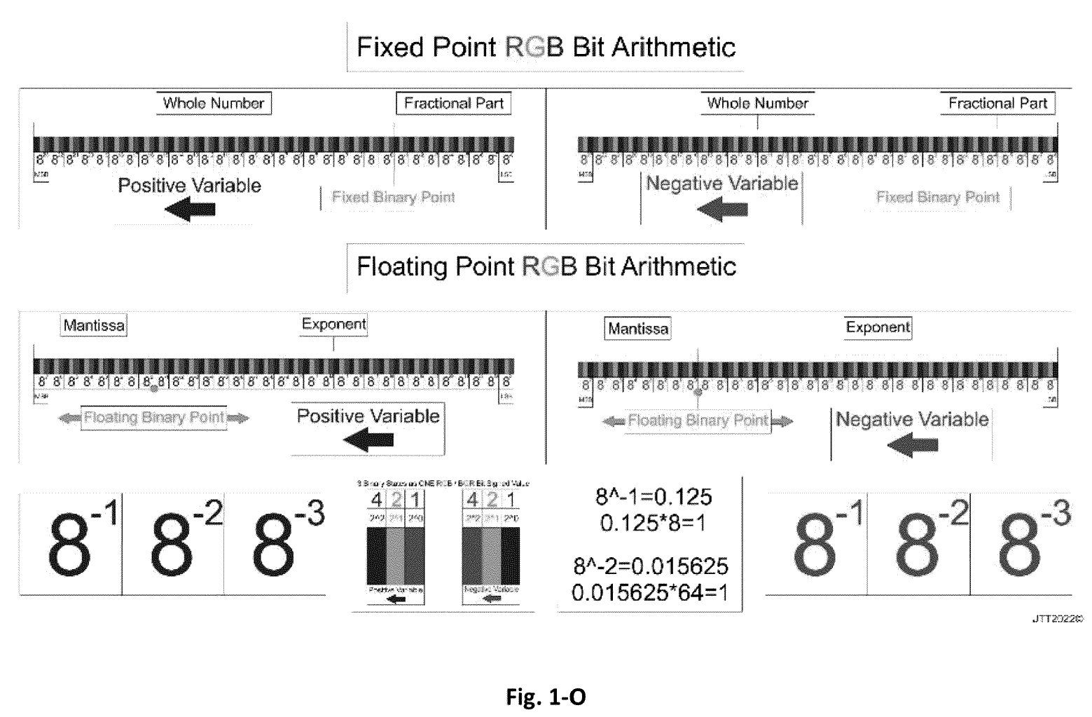

FIG. 1A shows an RGB Bit Logic Computation System 100 in which one or more of the disclosed methodologies or technologies can be implemented, for example, generating, storing, exchanging, or processing data using RGB Bit logic. In an embodiment, the RGB Bit system 100 includes an RGB (Red, Green, and Blue) Bit generator 102 configured to generate RGB Bit information forming part of one or more RGB Bits 104. In an embodiment, each RGB Bit comprises one or more RGB Bit logic states 106. Non-limiting examples of RGB Bit logic states 106 include electromagnetic states, magnetic states, color states, hue states, tint states, tone states, shade states, polarity states (e.g., positive, neutral, negative, odd magnetic polarity geometric architectures, even magnetic polarity geometric configurations, etc.), vibrational states, time varying RGB Bit logic states, geometric pattern varying RGB Bit logic states, and the like, or combinations thereof.

In an embodiment, the RGB Bit system 100 includes RGB Bit memory circuitry 108. In an embodiment, the RGB Bit memory circuitry 108 is configured to store the RGB Bit information. In an embodiment, the RGB Bit system 100 includes an RGB Bit Central Processing Unit (CPU) 110. In an embodiment, the RGB Bit CPU 110 is operably coupled to the RGB Bit memory circuitry 108. In an embodiment, the RGB Bit CPU 110 is configured to compute using RGB Bit logic 112.

In an embodiment, an RGB Bit 104 comprises RGB Bit information in the form an electromagnetic energy emitter array forming a geometric color pattern, a geometric color pattern display component, a magnetic array component, a light array component, a spaced-apart color and polarity distribution component, and the like. In an embodiment, an RGB Bit 104 comprises RGB Bit information stored in one or more electromagnetic energy emitter arrays and one or more magnetic components. Non-limiting examples of electromagnetic energy emitters include arc flashlamps, cavity resonators, ceramic patterned electrodes, conducting traces, continuous wave bulbs, electric circuits, electromagnetic energy emitters, electro-mechanical components, incandescent lights, laser diodes, lasers, light-emitting diodes (LEDs) (e.g., organic light-emitting diodes (OLEDs), polymer light-emitting diodes, polymer phosphorescent light-emitting diodes, microcavity light-emitting diodes, high-efficiency UV light-emitting diodes, and the like), optical fiber bundles, quantum dots, or the like, or other general electromagnetic energy emitting components that may be configured to provide an electromagnetic signal having a peak emission wavelength. Non-limiting examples of magnetic components include magnetic field loops, electromagnetic energy emitters, magnetic coils, magnetic field arrays, metamaterial arrays, coil arrays, and the like.

In an embodiment, the RGB Bit system 100 includes one or more sensors 114 operable to detect (e.g., assess, calculate, determine, gauge, measure, monitor, quantify, resolve, sense, or the like) an RGB Bit logic state 106. Non-limiting examples of sensors 114 include acoustic sensors, charge-coupled devices (CCDs), complementary metal-oxide-semiconductor (CMOS) devices, electromagnetic energy sensors, electromechanical sensors, electro-optical sensors, Hall effect sensors, image sensors, photodiode arrays, infrared sensors, magnetic sensors, optical sensors, radio frequency sensors, Reed switches, thermo sensors, transducers, ultraviolet sensors, and the like. In an embodiment, the RGB Bit system 100 includes one or more optical sensors configured to detect a physical quantity of light and transduce it into an electrical signal indicative of one or more RGB Bit logic state 106. Non-limiting examples of optical sensors include cameras, CCDs (charge coupled devices), CMOS (complementary metal oxide semiconductor) image sensors, diffuse reflection sensors, photoconductive devices, photodiodes, photoactive sensors, photovoltaic cell, retro-reflective sensor, spectrometers, through beam sensors, and the like.

In an embodiment, the one or more sensors 114 include computational circuitry configured to detect a color change, a temporal pattern associated with a color change, a color distribution, and the like and generate RGB Bit logic states based on the detected color changes, a temporal pattern associated with a color change, a color distribution, and the like.

In an embodiment, changing the variability of the sensors 114 will change the timing and spacing. An example is the Ostwald color sensor (U.S. Pat. No. 4,694,286; incorporated herein by reference in full).

In an embodiment, the RGB Bit system 100 includes computational circuitry configured to generate color-based RGB Bit logic states 106, detect color-based RGB Bit logic states, and employ the RGB Bit logic states 106 in computation. In an embodiment, the RGB Bit system 100 includes computational circuitry configured to generate chromatic-based RGB Bit logic states 106, detect chromatic-based RGB Bit logic states, and employ the RGB Bit logic states 106 in computation. In an embodiment, the RGB Bit generator 102 comprises computational circuitry configured to generate RGB Bit logic states 106. In an embodiment, the RGB Bit logic states 106 comprise one or more color states, hue states, tint states, tone states, shade states, and the like. In an embodiment, the RGB Bit system 100 includes one or more optical sensors configured to detect a physical quantity of an electromagnetic signal including one or more color states, hue states, tint states, tone states, shade states, magnetic states, and the like and transduce it into an electrical signal indicative of one or more RGB Bit logic state 106.

In an embodiment, the RGB Bit generator 102 is a programmable variable impulse generator, for example an oscillator, configured to generate a magnetic spectral color clocking signal to coordinate actions of one or more RGB Bit CPUs 110. In an embodiment, the RGB Bit generator 102 is configured to generate vibrational signals which will subdivide and leverage into RGB Bit logic states 106 In an embodiment, the RGB Bit Generator 102 includes, for example, a magnetic color generating device such as an RGB Bit crystal resonating oscillator, which clocks color and magnetic odd and even building blocks, or vectors known as RGB Bit states 106.

In an embodiment, the RGB Bit generator 102 includes, for example, a magnetic color generating device such as an RGB Bit crystal resonating oscillator, which assembles color and magnetic odd and even building blocks to form an RGB Bit 104. In an embodiment, the RGB Bit system 100 transitions from one RGB Bit logic state 106 to another RGB Bit logic state by modulating the color-magnetic spectral state of one or more RGB Bits 104. In an embodiment, the RGB Bit Generator 102 detects a magnetic state using a hardware sensor 114 including, for example, a reed switch. In an embodiment, the RGB Bit Generator 102 detects a state using an optical sensor which determines the presence or absence of a color and identifies the color state.

In an embodiment, the RGB Bit system 100 includes computational circuitry configured to generate color based RGB Bit logic states 106, detect color based RGB Bit logic states 106, and employ the RGB Bit logic states 106, in computation. For example, in an embodiment, the RGB Bit system 100 includes an Arduino open-source microcontroller CPU board including an RGB Bit CPU 110 and one or more RGB Bit transmitters 116, RGB Bit receivers 118, or RGB Bit transceivers. In an embodiment, during operation, an Arduino CPU sends a preprogrammed RGB Bit 104 to the RGB Bit transmitter 116, which is transmitted and interpreted with timing and synchronization, for example, on a preprogrammed quantum dot. In an embodiment, every time the RGB Bit system 100 cycles in a feedback loop, an endless loop of instructions can be created and given to a computer that has no final step. In an embodiment, the RGB Bit feedback loop 104 occurs when the output is routed back as input as part of a chain or cause or effect that forms a circuit or loop, feeding back into itself, with timing and spacing. In an embodiment, the RGB Bit opto-coupler feedbacks into the loop. In an embodiment, the microprogrammed information is sent via the RGB Bit transmitter 116. In an embodiment, a second Arduino is hooked up to the first Arduino and accepts and interprets the RGB Bit information.

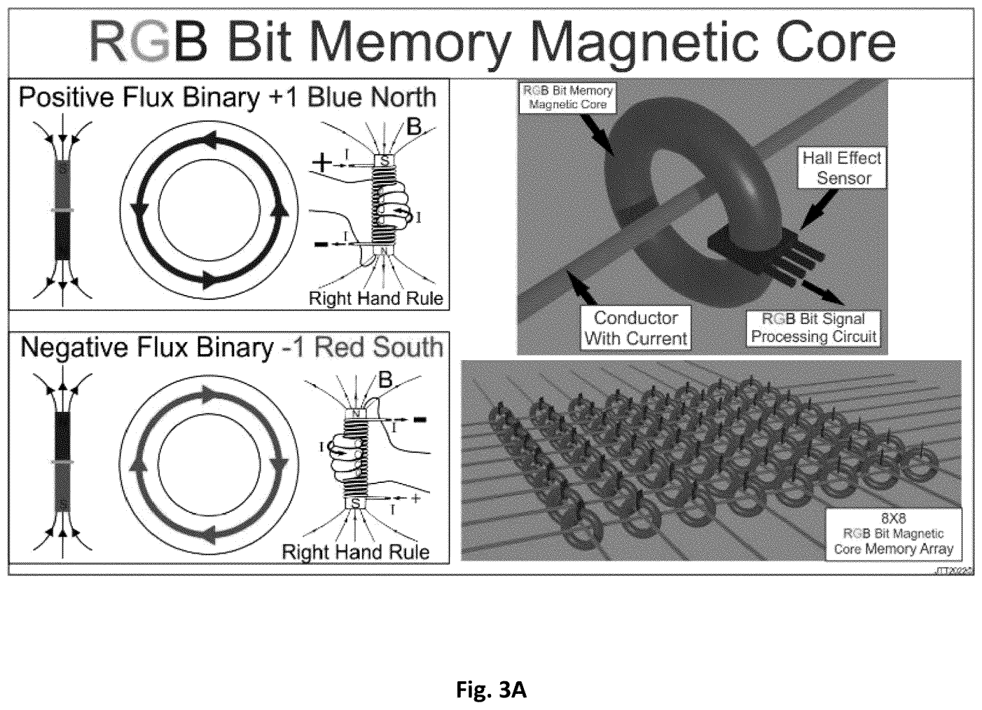

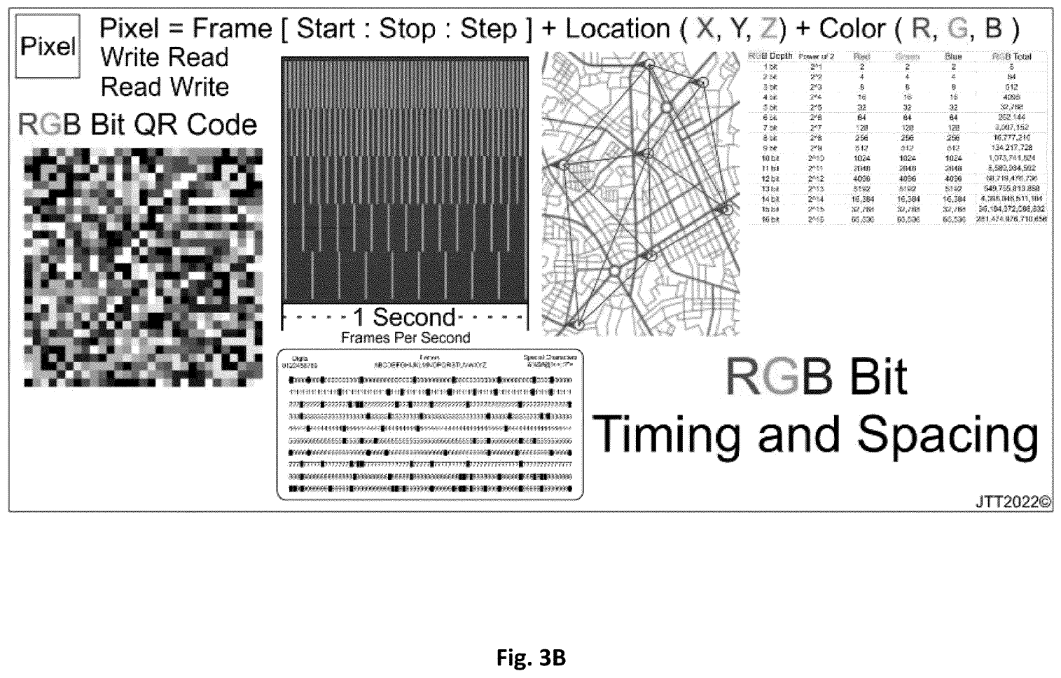

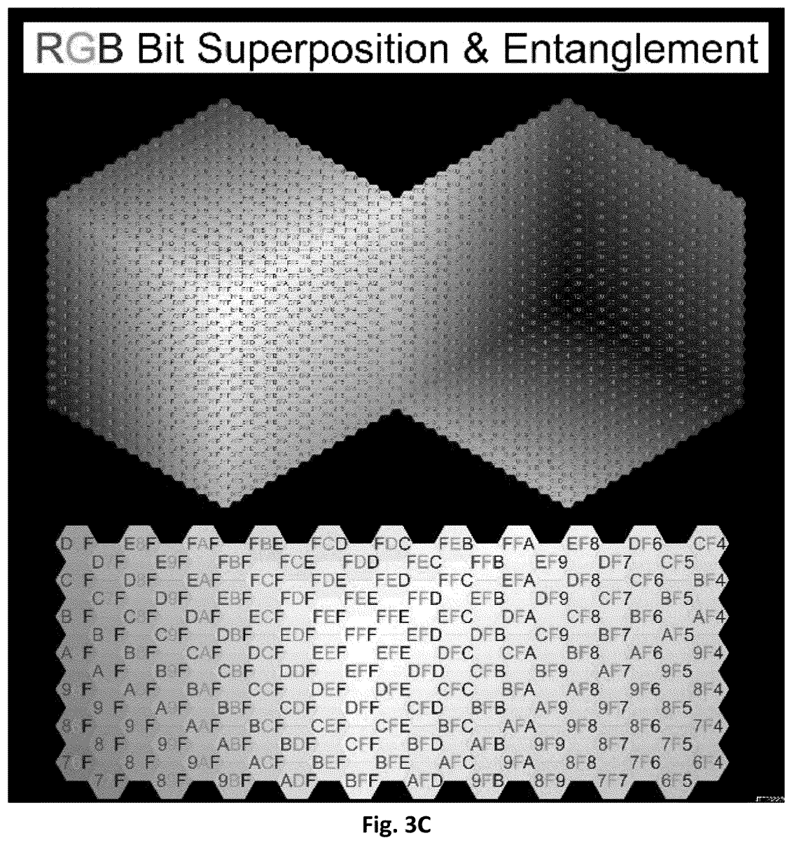

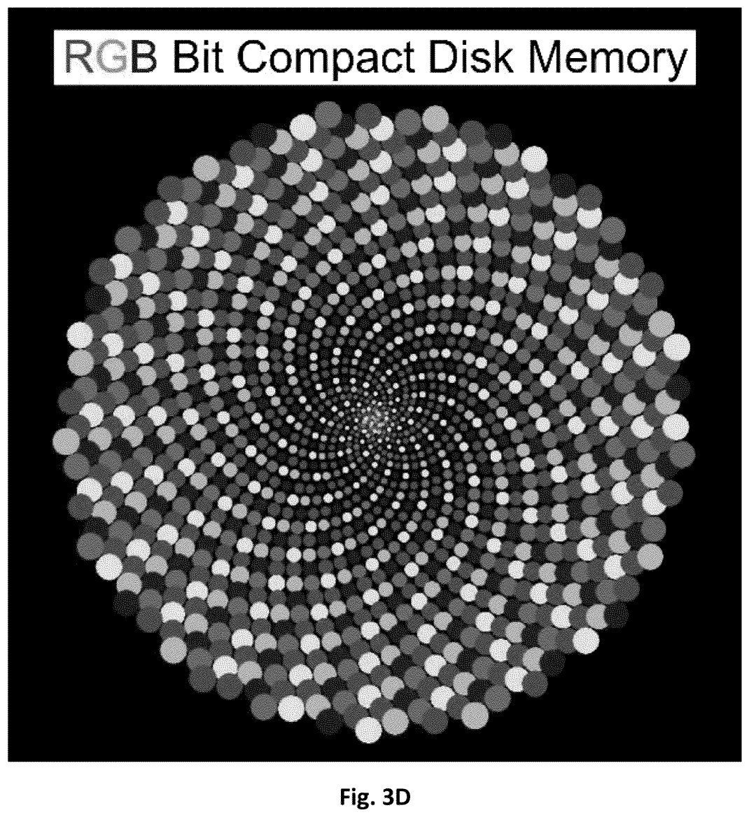

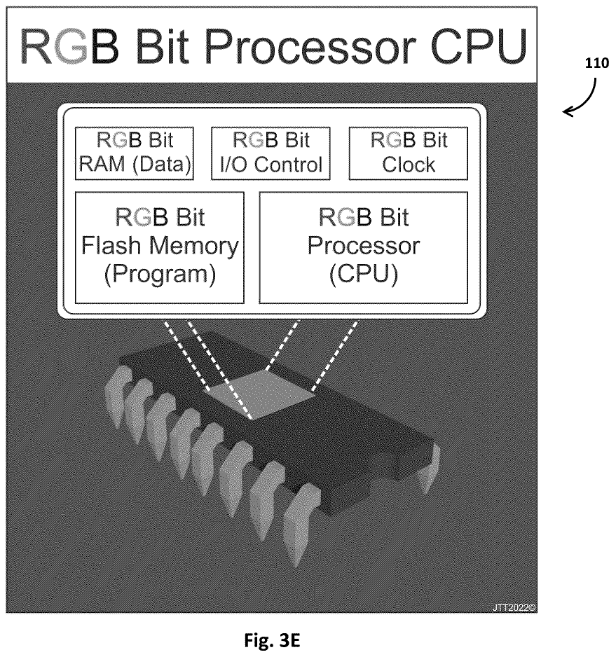

An example of an RGB Bit CPU 110 is shown in FIG. 3E. An RGB Bit CPU 110 is shown with memory and programmable input/output peripherals, an integrated circuit that contains its own RGB Bit CPU 110 along with memory 108 and associated circuits controlling some or all the functions of an electronic device. In an embodiment, the RGB Bit CPU 110 includes circuitry configured to compute RGB Bit logic states 106 responsive to integration of at least one RGB Bit and determine a color-magnetic state associated with at least one RGB Bit 104. A conventional CPU consists of the electronic circuitry that executes instructions comprising a computer program. An RGB Bit CPU 110 performs basic arithmetic, logic, controlling, and input/output (I/O) operations specified by the instructions in the program. This contrasts with external components such as main memory and I/O circuitry, and specialized CPUs such as graphics processing units (GPUs).

In an embodiment, the RGB Bit CPU 110 executes instructions using RGB Bits 104 having states encoded as spectral colors, polarity, magnetic imagery, patterns, hue saturation, tints, distances and creates a color distribution instruction set, each representing a different color or polarity with timing and spacing. In an embodiment, an example is an RGB Bit 104 modified Arduino CPU chip architecture that is programmable and allows the creation of individual programs to control the execution of instructions. In an embodiment, the RGB Bit software Is an operating program which instructs the RGB Bit 104 hardware main memory 108, control unit, and ALU (Arithmetic-Logic Unit) and batches instructions using RGB Bits to fetch, decode, execute, and store memory. Information is decoded from RAM and goes back to the ALU to store back in RAM.

With reference to FIG. 1A, in an embodiment, the RGB Bit logic states 106 comprise physical logic components representing and storing chromatic and achromatic states. In an embodiment, saturation is a determining factor in distinguishing one RGB Bit logic state 106 from another RGB Bit logic state 106. In an embodiment, intensity and vividness of a color is created by saturation. The absence or presence of saturation determines whether a state is chromatic or achromatic. In an embodiment, chromatic colors are defined by the peak emission wavelength of an electromagnetic energy emitter forming part of an RGB Bit logic state 106.

In an embodiment, magnetic polarity is a determining factor in distinguishing one RGB Bit logic state 106 from another RGB Bit logic state 106. In an embodiment, the rate of change between magnetic polarity events is a determining factor in distinguishing one RGB Bit logic state 106 from another RGB Bit logic state 106. In an embodiment, rate of change between color events is a determining factor in distinguishing one RGB Bit logic state 106 from another RGB Bit logic state 106.

In an embodiment, an RGB Bit logic state 106 is determined by detection of timing and spacing of an impulse, using the subdivision of light, polarity and vibration in unifying color and polarity. In an embodiment, each RGB Bit logic state 106 is represented by a color. An RGB Bit logic state 106 is determined by detecting the type of event and translated into a computation. In an embodiment, each color or magnetic impulse represents a different RGB Bit logic state 106 or a different way of storing data. For example, in an embodiment, the RGB Bit logic state 106 comprises a magnetic spectral bit and is varied by modulation of one or more RGB Bit logic state characteristics. Non-limiting examples of RGB Bit logic state characteristics include polarity, paths, hue saturation values, lightness or brightness, chromatic and achromatic depth, radians, magnetic vector equilibriums, color filters, prisms, mathematical functions, magnetic functions, magnetic hysteresis functionality, and the like.

In an embodiment, RGB Bits 104 comprise combination of magnetic domains (neutral, negative, positive) and color domains (Red, Green, and Blue). In an embodiment, the hierarchy of the architecture is the RGB Bit 104 from which all subdivisions stems. In an embodiment, the RGB Bit system 100 includes circuitry 120 configured to synchronize a timing function which transmits, receives, and interprets RGB Bit instruction sets, RGB Bit colors and associated information.

For example, in an embodiment, the RGB Bit system 100 includes an RGB Bit clock controller 126 configured to regulate an RGB Bit timing process, RGB Bit spacing process, and RGB Bit speed process associated with a plurality of RGB Bit computations. Non-limiting examples of an RGB Bit clock controller 126 include clock generators, clock signal circuitry, clock multipliers, CPU clocks, and the like. In an embodiment, the RGB Bit clock controller 126 is operably coupled to an RGB Bit color light or magnetic sensor clocking timing function identifying it as its own RGB Bit magnetic spectral memory state, the moving of something from its initial placement or position, i.e., start, stop, step. In an embodiment, the RGB Bit clock controller 126 regulates RGB Bit timing, RGB Bit spacing, and RGB Bit speed of all RGB Bit computer functions. Timing and spacing are the changing of states over a given period. In an embodiment, the RGB Bit memory circuitry 108 comprises state possibilities, built upon the three energic RGB Bit magnetic spectrum values and inversions of red, green, and blue. Additional states are manipulated, for example speed, distance, vibrations, radians hue saturation, loopback iterations, and time and the changes, timing, spacing, frequencies or alternating color polarities. Frequency is the number of occurrences of a repeating event per unit over RGB Bit timing or RGB Bit repetition, a succession of repetitions of a pattern or a multidimensional geometric structural pattern, each in a new position.

In an embodiment, the RGB Bit memory circuitry 108 includes an RGB Bit color light sensor timing clocking function identifying it as its own RGB Bit magnetic spectral memory state using an RGB Bit color light or magnetic sensor clocking timing device identifying it as its own RGB Bit magnetic spectral memory state, the moving of something from its initial placement or position, i.e., start, stop, step. The RGB Bit clocking/counting regulates RGB Bit timing, RGB Bit spacing, and RGB Bit speed of all RGB Bit computer functions. Timing and spacing are the changing of states over a given period. The RGB Bit memory circuitry consists of changing state possibilities, built upon the three energic RGB Bit magnetic spectrum values and inversions of red, green, and blue. Additional states are manipulated, for example speed, distance, vibrations, radians hue saturation, loopback iterations, and time and the changes, timing, spacing, frequencies or alternating color polarities. Frequency is the number of occurrences of a repeating event per unit over RGB Bit timing or RGB Bit repetition, a succession of repetitions of a pattern or a multidimensional geometric structural pattern, each in a new position. The RGB Bit memory circuitry stores RGB Bit states by creating an RGB Bit magnetic spectral imprint in memory 108.

In an embodiment, the RGB Bit Generator 102 is configured to detect the presence of a magnetic field using a hardware sensor 114 for example, a reed switch configured to detect the presence of a magnetic state. In an embodiment, the RGB Bit Generator 102 is configured to detect a color and identify the color state using one or more optical sensors. An example is a camera interpreting RGB Bit color states using a rotating RGB Bit color wheel interacting with the color filters FIG. 1B. In an embodiment, the rotating wheel will hit the mirror on a DLP (Digital Light Processing) chip with a solenoid. When activated, it turns on an angle and reflects the light through the optics with the preprogrammed correct timing and spacing. In an embodiment, the DLP is a chip based on optical micro-electro-mechanical technology that uses a digital micromirror device. It contains a resolution of the image in its compressed form to fit into that resolution and preprogrammed pixel plotting. In an embodiment, the RGB Bit DLP chip is the processor which controls the DMD (Digital Micromirror Device) and is synchronized with the rotary motion of the color wheel, controlling lasers with prisms to provide this functionality, providing the X, Y and Z plotting.

A conventional CPU performs 4 basic functions: store, fetch, decode, and execute. In an embodiment, the RGB Bit CPU 110 includes circuitry configured to compute RGB Bit logic 112 responsive to integration of at least one RGB Bit 104 and determine a color-magnetic state associated with at least one RGB Bit 104 to translate instructional commands performing mathematical functions. In an embodiment, the RGB arithmetic function component is preprogrammed into the RGB Bit CPU 110 to perform tasks based upon combinational logic of color coding and magnetic states. In an embodiment, the RGB Bit CPU 110 comprises electronic circuitry that executes instructions comprising an RGB Bit computer program using color spectral and magnetic commands to perform basic arithmetic, logic, controlling, and input/output (I/O) operations specified by the instructions in the program. This contrasts with external components such as main memory and I/O circuitry, and specialized CPUs such as graphics processing units (GPUs). In an embodiment, the RGB Bit CPU 110 executes instructions using RGB Bits 104 comprising a computer system using such embodiments as spectral colors, polarity, magnetic imagery, patterns, hue saturation, tints, distances and creates a color distribution instruction set, each representing a different color and polarity with timing and spacing. In an embodiment, an Arduino CPU chip architecture is programmable and allows the creation of individual RGB Bit programs to control the execution of instructions. In an embodiment, an RGB Bit software is an operating program which instructs the RGB Bit hardware main memory 108, RGB Bit CPU 110, ALU and batches instructions using RGB Bits 104 to activate the fetch execute cycle: fetch, decode, execute, and store memory. It decodes information from RAM and goes back to the ALU to store back in RAM.

As shown in FIG. 1A, the RGB Bit system 100 includes an RGB Bit generator 102 and an RGB Bit memory circuitry 108 configured to store RGB Bit information including, for example, a magnetic state 122. In an embodiment, the magnetic state 122 comprises a polarity (e.g., a positive state, a neutral state, or a negative state). In an embodiment, the magnetic state 122 comprises an odd or even magnetic polarity configuration. In an embodiment, the magnetic state 122 comprises a data path, a collection of functional RGB Bits 104 such as arithmetic logic units or multipliers that perform data processing operations, register information 300, and the communications protocol transports 100. In an embodiment, a larger data path can be made by joining more than one RGB Bit data path.

In an embodiment, the magnetic state 122 comprises RGB Bit spectral radians hue saturation values. Hue is assigning spectral rotation. In an embodiment, saturation is the amplitude of the signal. In an embodiment, magnetic state 122 comprises a lightness and brightness state, a visual perception of the luminance of an object. In an embodiment, lightness is a prediction of how an illuminated color will appear. In an embodiment, the magnetic state 122 comprises chromatic and achromatic colors, or groups of colors. In an embodiment, saturation is a determining factor in distinguishing one from another. In an embodiment, intensity and vividness of a color is created by saturation. The absence or presence of saturation determines whether a color is chromatic or achromatic. In an embodiment, chromatic colors are ones where there is only one peak emission wavelength that predominates colors like the RGB Bit logic state 106 of red, green, and blue. They are referred to as pure colors. Achromatic colors have no dominant hue. They are the colors that contain all wavelengths in equal amounts such as white, gray, and black. In an embodiment, achromatic colors are shaded or tinted.

In an embodiment, the magnetic state 122 comprises radians, a unit of angle equal to an angle at the vertex center of a circle whose arc is equal in length to the radius. In an embodiment, an RGB Bit 104 is represented by radians in defining its pathway functionality, rotation around an arc. In an embodiment, the RGB Bit magnetic state 122 comprises RGB Bit magnetic vibrational vector equilibriums. In an embodiment, RGB Bit magnetic states 122 comprise color filters, a photographic filter that absorbs light of predetermined colors. In an embodiment, the RGB Bit system absorbs and transmits light, for example, a red filter will absorb all other colors such that only red is reflected. In an embodiment, the magnetic state 122 comprises odd and even polarity mathematical and magnetic functions. In an embodiment, the magnetic state 122 comprises RGB Bit variable values. A value is a defined object. For example, the letter A and the number 1. Or, Red=1. Vector is a quantity having a direction and magnitude connecting Point A to Point B.

In an embodiment, the magnetic state 122 comprises a magnetic RGB Bit hysteresis loop, the dependence of the state of a system on its history. For example, a magnet may have more than one possible magnetic moment of timing and spacing in a given magnetic field, depending on how the field has changed in the past magnetic moment. In an embodiment, plots of a single component of the moment often form a loop or hysteresis curve, where there are different values of one variable depending on the direction of change of another variable. The dependence of the state of a system on its history is the basis of memory in a hard disk drive. It is often associated with changes such as phase transitions. In an embodiment, the RGB Bit magnetic state 122 comprises feedback loops used to control the output of electronic devices. In an embodiment, a feedback loop is created when all or some portion of the output is fed back to the input. A device is said to be operating an open loop if no output feedback is being deployed and closed loop if feedback is being deployed. One example is the TV to feedback loop, taking the image, capturing it and putting it back on the screen. In an embodiment, a feedback loop allows the capture of timing and spacing comparing it to a crystal resonator as used in the RGB Bit Generator 102.

In an embodiment, the RGB Bit Generator 102 includes memory circuitry configured to determine an RGB Bit magnetic spectrum state based on loop logic and spectral logic associated with RGB Bit hysteresis magnetic domains 108. In an embodiment, the RGB Bit Generator 102 comprises processing RGB Bit memory circuitry 108 operably coupled to robotic components, machines, or electro mechanical devices configured to carrying out a complex series of actions automatically. Using preprogrammed RGB Bit algorithms for finite sequencing of rigorous instructions, specific problems and computations are performed using color and magnetic states. For example, an Arduino digital CPU is programmed to only recognize zeros and ones. In an embodiment, the function parameters are preprogrammed using state specific pins hardwired into the RGB Bit CPU 110 for input and output. The magnetic sensor creates the desired input. In an embodiment, once the magnetic sensor is triggered, the desired output can be achieved. In an embodiment, the color is the generator, the sensor is waiting for it to be triggered, then the preprogrammed RGB Bit algorithms are carried out 100.

In an embodiment, the RGB Bit Generator 102 includes circuitry operably coupled to a magnet or a component configured to generate a magnetic field. In an embodiment, the RGB Bit Generator 102 includes prisms with refracting faceted geometric lenses at angles with each other that separate light into a spectrum of RGB Bit colors. The angle of the way the light hits the prisms behaves as a geometric prism. In an embodiment, the RGB Bit generator shifts timing and spacing, providing the separation of the signals, the refraction.

In an embodiment, the RGB Bit system 100 includes RGB Bit memory circuitry 108. In an embodiment, RGB Bit memory circuitry 108 is addressed with content using impulse spectral inscription for fetching scalars, vectors, matrixes, tensors, and multi-dimensional tensors. In an embodiment, the RGB Bit memory circuitry 108 is configured to store the RGB Bit information: for example, using a bundle of optical fibers that maintain a particular color which transmits light of generated wavelengths, functioning as a transducer. In an embodiment, transducers are employed to convert a signal from one form of energy into another. For example, in an embodiment, the RGB Bit system 100 includes one or more transducers configured to detect a physical quantity of an RGB Bit memory circuitry 108 and transduce it into an electrical signal indicative of one or more RGB Bit logic state 106.

In an embodiment, the RGB Bit memory circuitry 108 stores the RGB Bit information color by programming each of the fibers to have a particular wavelength. The RGB Bit memory circuitry 108 maintains the memory, reads a logic state—for example, optical sensors, color generated by activating LEDs or creating a color spectrum read by using magnetic and optical sensors. This data is manipulated by programming each of the optical fibers to have a wavelength, and the electronic circuitry to maintain and make it a stored memory. In an embodiment, the RGB Bit memory circuitry 108 reads the logic states, generated by activating a LED or creating a color spectrum, read using optical sensors and manipulated by generating algorithms. In an embodiment, the RGB Bit memory circuitry 108 includes memory circuitry configured to generate, read, write, and store an RGB Bit logic state 106.

In an embodiment, the RGB Bit memory 108 includes circuitry configured to interpret color and magnetism into the correct RGB Bit hysteresis loop function magnetic moment: for example, orientation, superposition, entanglement memory, fetching locations in timing and spacing and the like. An example includes the functioning of the memory circuitry by storing the voltage present on an impulse signal whenever it is triggered by a control. RGB Bit memory circuitry 108 includes conventional fetching, decoding, executing, and storing memory RGB Bits 104. In an embodiment, newly processed RGB Bit information is written back to RGB Bit memory 108, executing, and storing into memory banks. Circuitry connects hardware such as a color sensor, actively fetching color sensor data. In an example, a camera provides reflection to use and diffuse light. It subdivides light into holographic chambers, both scattered, reflected and absorbed. In an embodiment, the hardware includes an electromagnetic and optical component. The memory core is how a hard drive CD system works. In an embodiment, the RGB Bit memory circuitry 108 uses the memory of RGB Bit spectral logic and its correct interpretation.

In an embodiment, the RGB Bit logic state 106 comprises magnetic memory polarity: a positive state, a neutral state, and a negative state including both odd and even magnetic polarity geometric configurations. An RGB Bit logic state 106 comprises a memory data path, a collection of functional RGB Bit units such as arithmetic logic units or multipliers that perform data processing operations, register information, and the communications protocol transports. In an embodiment a larger data path can be made by joining more than one RGB Bit data path.

In an embodiment, the RGB Bit logic state 106 comprises RGB Bit spectral memory radians hue saturation values. Hue is assigning spectral rotation. Saturation is the amplitude of the signal. In an embodiment, the RGB Bit logic state 106 comprises memory lightness and brightness, a visual perception of the luminance of an object. Lightness is a prediction of how an illuminated color will appear.

In an embodiment, the RGB Bit logic state 106 comprises memory chromatic and achromatic colors, groups of colors that can create a specific look or feel. In an embodiment, the RGB Bit logic state 106 comprises memory radians, a unit of angle equal to an angle at the vertex center of a circle whose arc is equal in length to the radius. In an embodiment, an RGB Bit uses radians in defining its pathway, rotating around an arc. In an embodiment, the RGB Bit logic state 106 comprises RGB Bit memory vibrational vector equilibriums.

In an embodiment, the RGB Bit logic state 106 comprises RGB Bit memory color filters, a photographic filter that absorbs light of certain colors. In an embodiment, the RGB Bit system 100, absorbs and transmits, for example, a red filter that will absorb all other colors such that only red is reflected. In an embodiment, the RGB Bit logic state 106 comprises memory prisms with refracting faceted geometric lenses at angles with each other that separate light into a spectrum of RGB Bit colors or the reverse 114.

In an embodiment, the RGB Bit analog and RGB Bit digital magnetic states 106 comprise odd and even mathematical magnetic memory functions. In an embodiment, the RGB Bit logic state comprises RGB Bit analog and RGB Bit digital magnetic states determined by odd and even mathematical magnetic memory functions. In an embodiment, the RGB Bit logic state 106 comprises variable memory values. A value is a defined object.

In an embodiment, the RGB Bit memory circuitry 108 comprises a memory magnet, a material or object that produces a magnetic field. In an embodiment, the RGB Bit memory circuitry 108 comprises a memory magnetic hysteresis loop, the dependence of the state of a system on its history. In an embodiment, the RGB Bit memory circuitry 108 comprises circuitry configured to determine a magnetic spectral state based on loop logic and spectral logic associated with RGB Bit hysteresis magnetic domains.

In an embodiment, the RGB Bit memory circuitry 108 comprises robotics, machines, especially ones programmable by a computer, capable of carrying out multiple memory complex series of actions automatically. This comprises the embedded control unit with RGB Bits. In an embodiment, the RGB Bit memory circuitry 108 comprises RGB Bit memory feedback loops used to control the output of electronic devices. In an embodiment, the RGB Bit memory circuitry 108 comprises one or more electromagnetic emitters forming part of an input RGB Bit logic state or an output RGB Bit logic state 106.

In an embodiment, the RGB Bit memory circuitry 108 includes one or more light-emitting diodes, laser diodes, microcavity light-emitting diodes, organic light-emitting diodes, polymer light-emitting diodes, polymer phosphorescent light-emitting diodes, or high-efficiency light-emitting diodes forming part of an input RGB Bit logic state or an output RGB Bit logic state 106. In an embodiment, the RGB Bit memory circuitry 106 includes one or more arc flashlamps, continuous wave bulbs, or incandescent emitters forming part of an input RGB Bit logic state or an output RGB Bit logic state. In an embodiment, the RGB Bit memory circuitry 108 includes one or more fiber lasers, lasers, or ultra-fast lasers forming part of an input/output RGB Bit logic state or an output RGB Bit logic state. In an embodiment, the RGB Bit memory circuitry 108 includes one or more quantum dots, electromagnetic energy emitters and receivers, electro-optical transducers, optical energy emitters, and optical fiber emitters forming part of an input RGB Bit logic state or an output RGB Bit logic state.

In an embodiment, the RGB Bit memory circuitry 108 includes, for example, a photo electric sensor configured to emit light from a transmitter and to detect the light reflected from a detection object with a receiver, prisms, and the like or other ways to capture reflected light, reflective chambers, holographic chambers, and the like 114.

In an embodiment, the RGB Bit memory circuitry 108 includes a programmable light to a frequency converter and inverter. In an embodiment, the RGB Bit memory circuitry 108 includes a configurable silicon photodiode and a current, voltage or resistivity to frequency converter. In an embodiment, the RGB Bit memory circuitry 108 includes a monolithic CMOS (Complementary Metal-Oxide Semiconductor) integrated circuit having a configurable silicon photodiode and a current to frequency converter.

In an embodiment, the RGB Bit memory circuitry 108 includes an RGB Bit color light sensor timing identifying it as its own RGB Bit magnetic spectral memory state and the changes, timing, spacing, frequencies or alternating color polarities. In an embodiment, the RGB Bit memory circuitry 108 is configured to change a color to a preprogrammed color geometric grid responsive to one or more inputs/outputs indicative of a color and magnetic change. For example, taking one RGB Bit and oscillating, through a color filter turns the white light to red, outputs to a LED array and goes to a preprogrammed image. In an embodiment, the RGB Bit memory circuitry 108 includes one or more RGB Bit magnetic impulse emitters and receivers forming part of an RGB Bit, combining into a magnetic state pixel array.

In an embodiment, the RGB Bit memory circuitry 108 includes one or more light-emitting diodes, laser diodes, microcavity light-emitting diodes, organic light-emitting diodes, polymer light-emitting diodes, polymer phosphorescent light-emitting diodes, or high-efficiency light-emitting diodes forming part of an RGB Bit pixel array. In an embodiment, the RGB Bit memory circuitry 108 is configured to change an RGB Bit pixel array from a first pixelated color distribution to a second pixelated magnetic emulated color distribution, different from the first 100.

In an embodiment, the RGB Bit system 100 includes an RGB Bit Central Processing Unit (CPU) 110. In an embodiment, the RGB Bit CPU 110 is operably coupled to the RGB Bit memory circuitry 108. In an embodiment, the RGB Bit CPU 110 is configured to compute using RGB Bit logic 112.

In an embodiment, the RGB Bit Logic Computation System CPU 110 includes circuitry configured to compute RGB Bit logic responsive to integration of at least one RGB Bit and determine a magnetic state associated with at least one RGB Bit. A CPU, also called a microcontroller, main microcontroller, or microprocessor, is the electronic circuitry that executes instructions comprising a computer program 100. A CPU performs basic arithmetic, logic, controlling, and input/output (I/O) operations specified by the instructions in the program. This contrasts with external components such as main memory and I/O circuitry, and specialized CPUs such as graphics processing units.

In an embodiment, the RGB Bit CPU 110 executes instructions using RGB Bits 104 comprising a computer program: color, spectral colors, polarity, magnetic imagery, patterns, hue saturation, tints, and distances, creating a color distribution instruction set, each representing a different color or polarity with timing and spacing. An example is the Arduino CPU chip's architecture that is programmable and allows the creation of individual RGB Bit software programs to control the execution of instructions.

In an embodiment, the RGB Logic Computation System 100 comprises an RGB Bit generator 102, an RGB Bit optical (opto) coupler 124, RGB Bits 104, RGB Bit logic states 106, RGB Bit memory circuitry 108, and an RGB Bit CPU 110. FIG. 1B depicts an example of an RGB Bit Generator 202 including a rotating or oscillating color wheel operating as an oscillator. During operation, when the RGB Bit Generator 202 is rotating or oscillating, the RGB Bit Generator transitions through different magnetic color spectral states including outputs to a specific position, instructing it on how long to run and the like. In an embodiment, the color sensor is the input, waiting for a trigger. When the color trigger picks up a state change, a color sensor containing white LEDs sends out a white light. For example, when the light interprets a green block (shown in the prototype as the green LEGO®) absorbs all the light except for green. The green block will reflect only the green light through the Bayer filters. The Bayer filter has color filters in front of photo sensors illuminating the color filter in front of the hardware, subdividing light. The Bayer filter stops the unwanted signals from coming through. The sensor is capturing the reflected light, subdividing the white light similar to a prism. In an embodiment, an RGB Bit Generator 102 only allows the specific RGB Bit divisions of the light to go through the filter. A color sensor is a type of “photoelectric” sensor which emits light from a transmitter, and then detects the light reflected back from the detection object with a receiver. In this example, the Bayer filter is the receiver.

With reference to FIG. 1A and FIG. 1B, in an embodiment, the RGB Bit algorithm takes an input to create a preprogrammed output. In an embodiment, the RGB Bit Logic Computation System 100 includes sensors 114 configured to detect magnetic states and color state changes. For example, a camera 114 interprets RGB Bit color states 106 generated by a rotating RGB Bit color wheel interacting with the color filters. In an embodiment, the rotating wheel will hit the mirror on a DLP (Digital Light Processing) chip with a solenoid. In an embodiment, when activated, it turns on an angle and reflects the light through the optics with the preprogrammed correct timing and spacing. In an embodiment, the RGB Bit DLP is a chip based on optical micro-electro-mechanical technology that uses a digital micromirror device. It can also be used as memory. It contains a resolution of the image in its compressed form to fit into that resolution and preprogrammed pixel plotting. In an embodiment, the RGB Bit DLP chip is the processor which controls the DMD (Digital Micromirror Device) and is synchronized with the rotation motion of the color wheel, controlling lasers with prisms to provide this functionality, providing the X, Y and Z plotting.

In an embodiment, RGB Bits states 106 are converted into component signals via the RGB Bit optical coupler. An RGB Bit state generator 102 encodes information based upon color coding and magnetic states. In an embodiment, the RGB Bit system includes circuitry configured to acquire individual color-coded bit states and connect them to an RGB Bit CPU. In an embodiment, the RGB Bit system includes a magnetic color dependent CPU to translate color coded bit states into data which can be leveraged for functionality.

FIG. 1C shows how the system of FIG. 1B operates over a period of time. At Time T1, the green block is in front of the camera 114 and the color is detected. At Time T2, the motor rotates the color wheel (RGB Bit generator 202) so the blue block is now in front of the camera 114 and the color is detected. At Time T3, the motor rotates the color wheel so the red block is now in front of the camera 114 and the color is detected. In this example, three color segments may form a single RGB bit. The rotation of the color wheel may be only in one direction (i.e., only clockwise or only counter-clockwise rotation), or the color wheel may be controlled to oscillate in both directions.

While FIGS. 1B and 1C show a color wheel with four blocks chosen from red, green, and blue, the color wheel is not limited in this manner. FIG. 1D shows alternative examples of color wheels that may be used. For instance, on the left, in RGB Bit generator 203, the same color arrangement is used from FIGS. 1B and 1C, except the colors are not blocks but are disposed continuously on the surface of the wheel itself. The right side of FIG. 1D shows RGB Bit Generator 204 in which several colors beyond red, green, and blue are used on the color wheel. As while be shown on the next figure, using multiple colors allows for the multiple states created by the RGB Bit combination. Therefore, the right side embodiment of FIG. 1D allows these multiple states to be directly placed on the color wheel, which saves processing time.

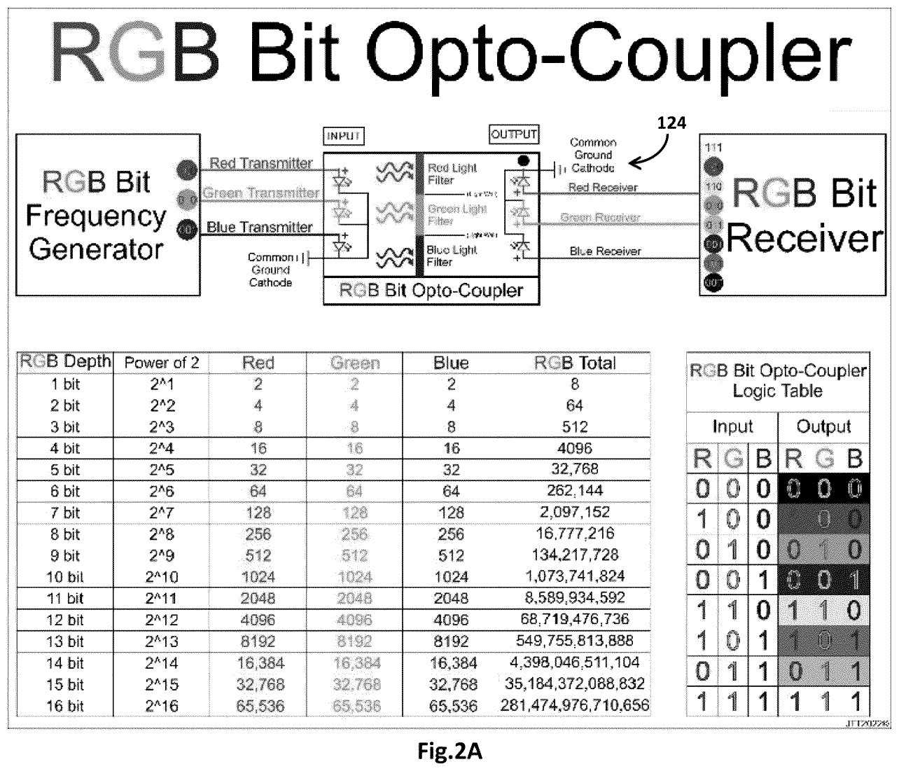

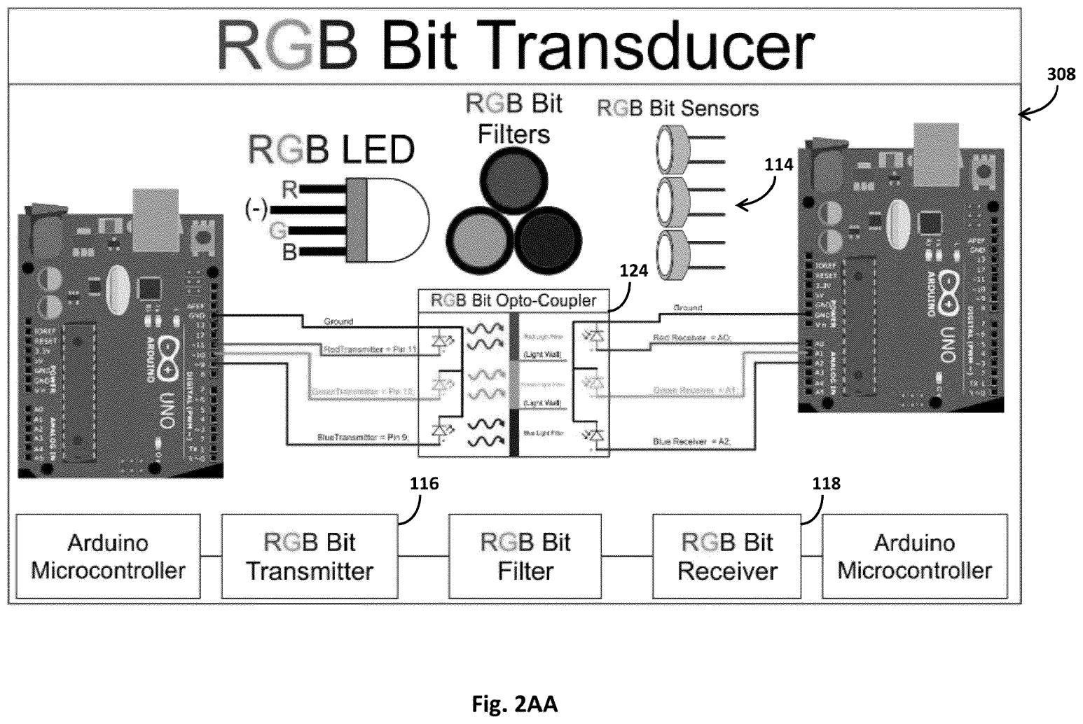

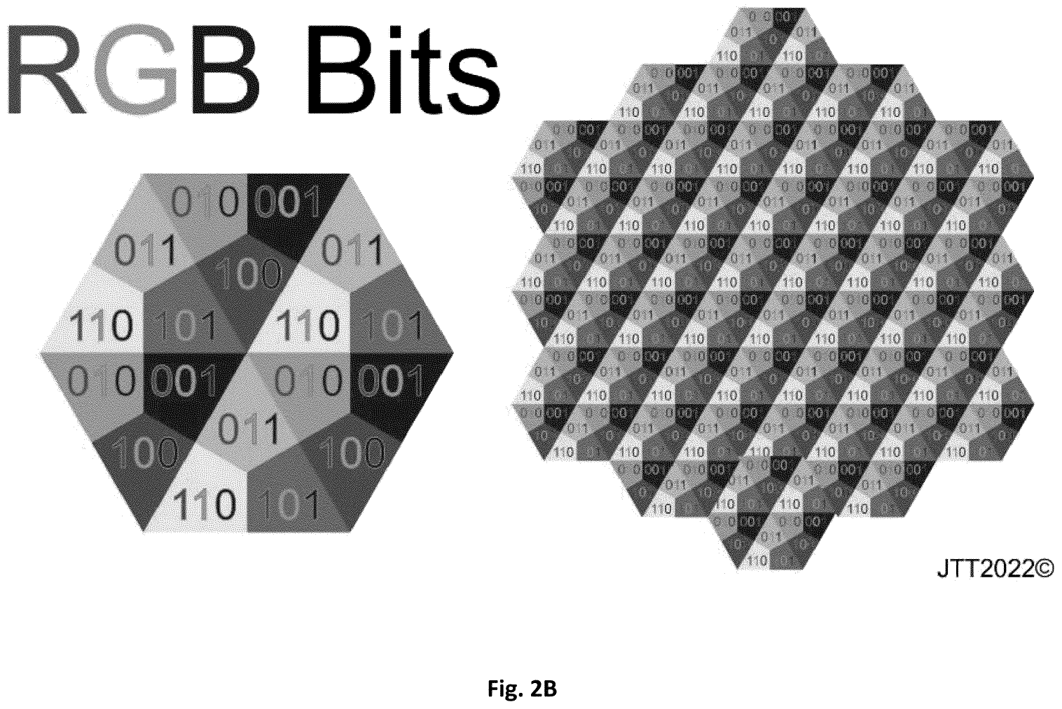

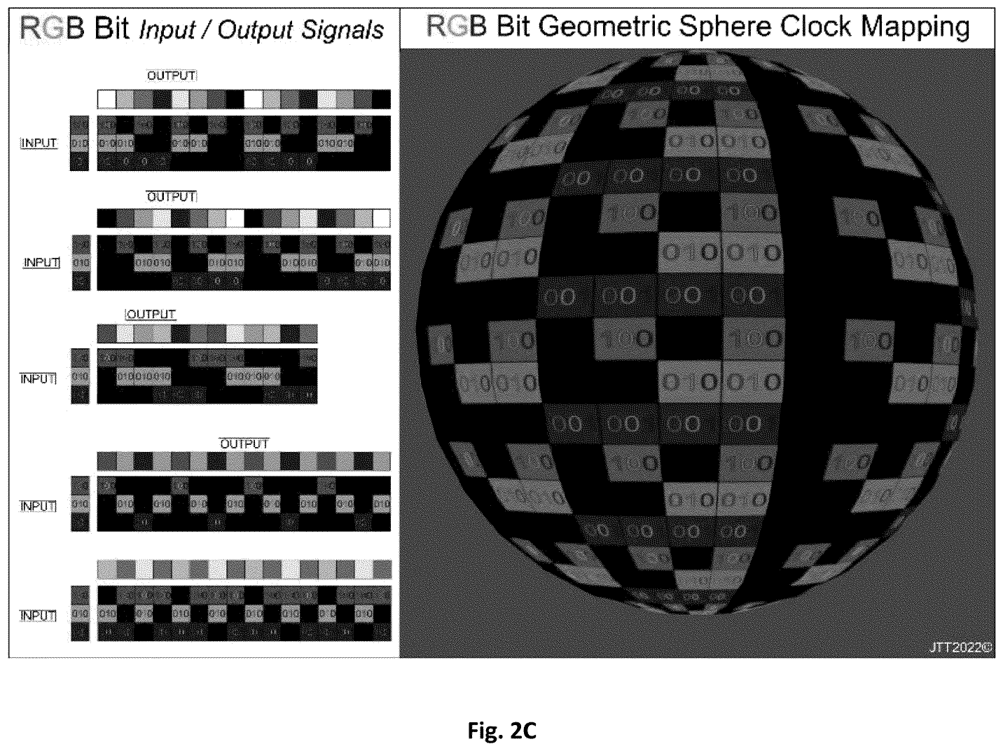

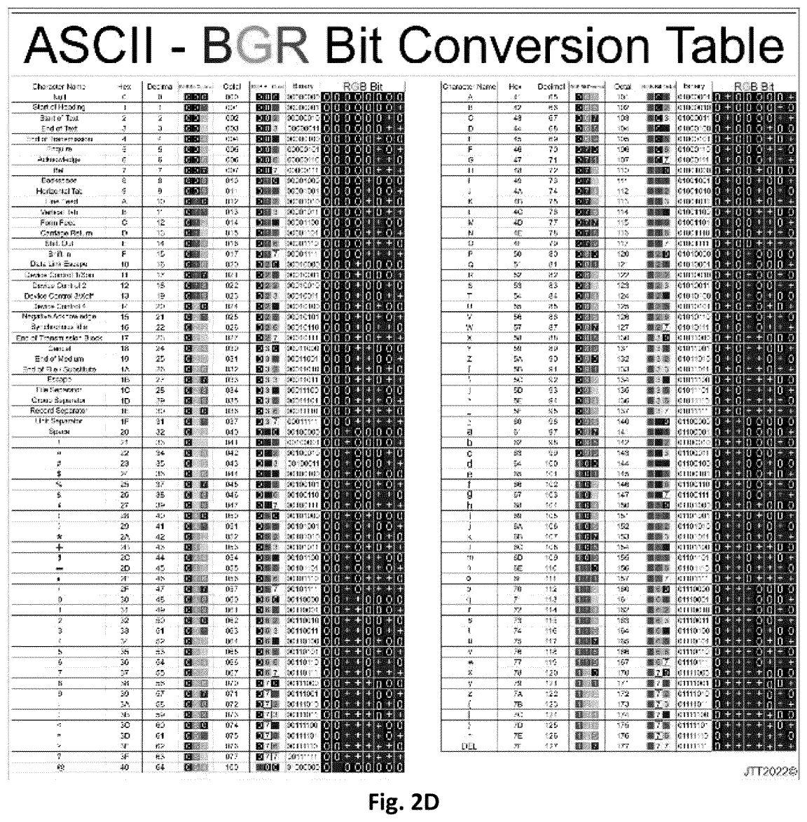

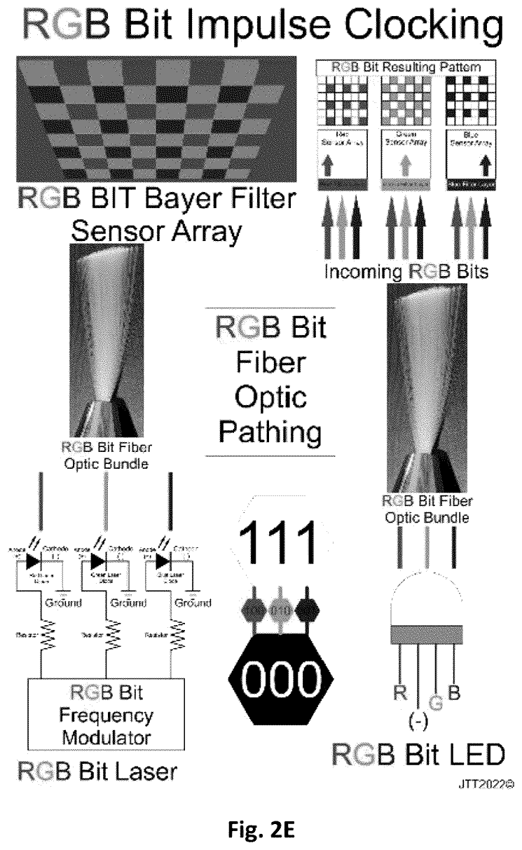

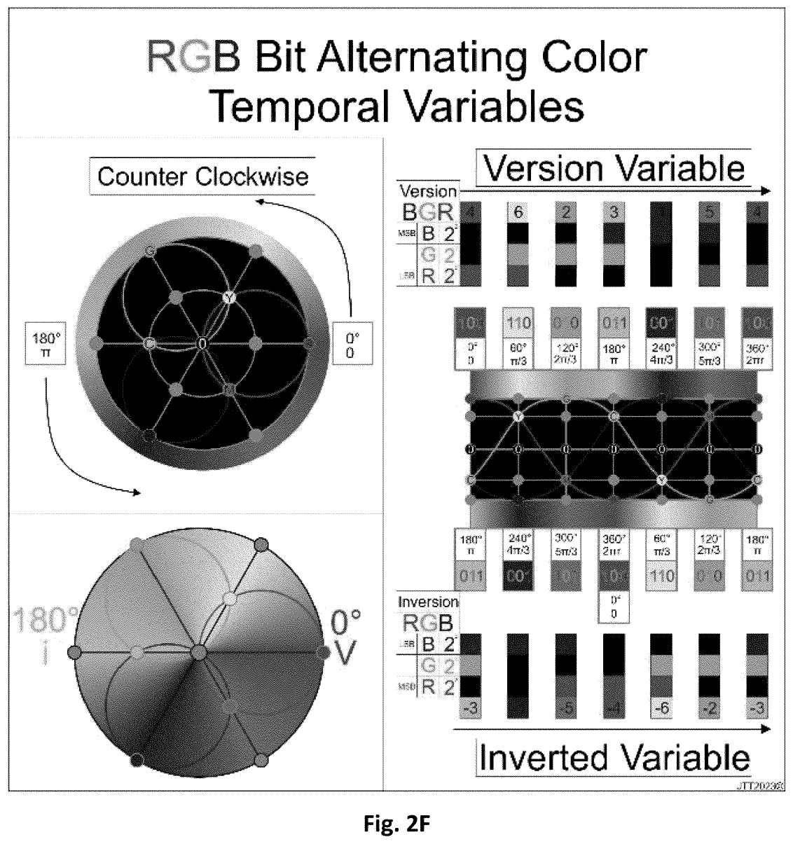

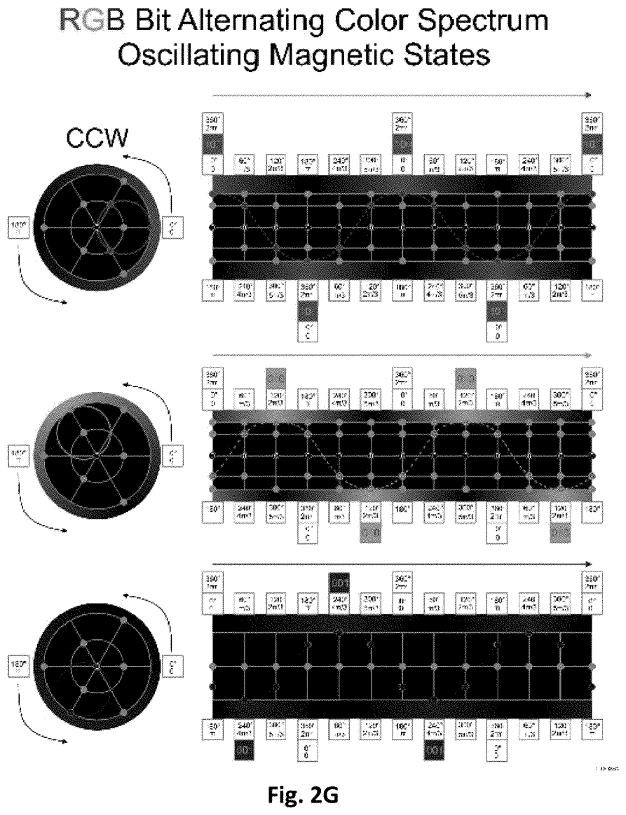

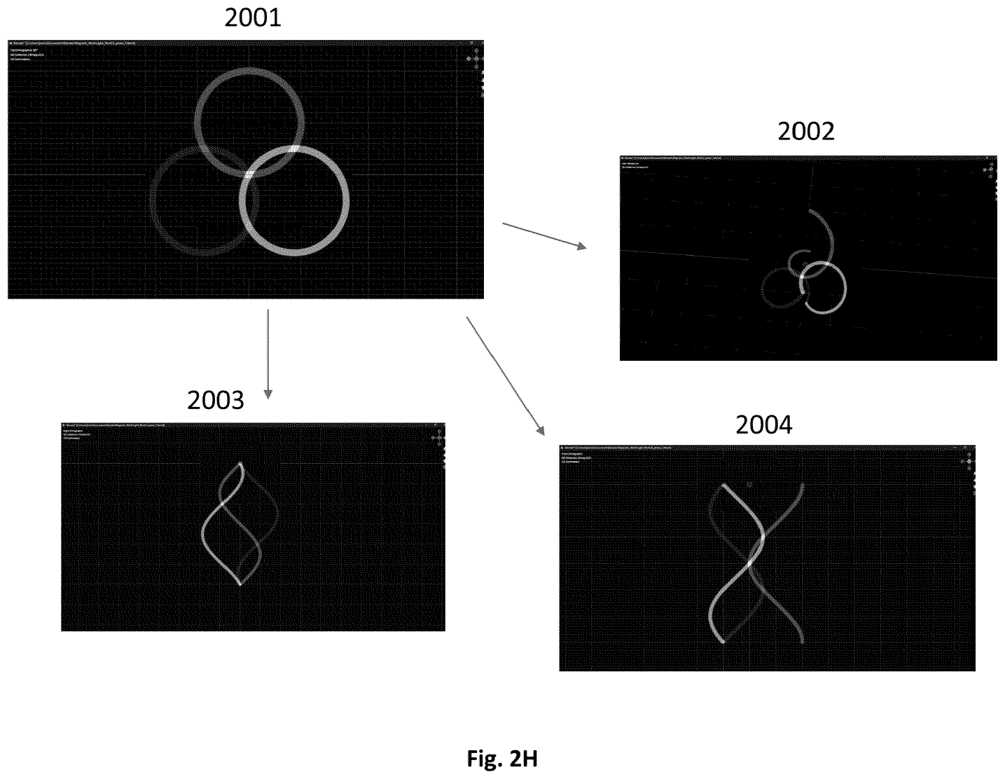

FIG. 1E illustrates a 2-dimensional graph of a three-dimensional RGB Bit Hysteresis Loop 302 showing magnetic states and color interdependence. In this example, the magnetic state in the B-H plane corresponds to the colors on the color wheel and therefore, the position in the hysteresis loop can be used to represent a specific color and can show the pathways to saturated colors. A hysteresis loop is added to the magnetic memory, showing the intersection at the same magnetic moment. Further detail is shown in the hexagonal grid illustrated in FIG. 2B. The function itself is defined by the magnetic function. It represents the pathways to saturated true signals. All colors are represented on the hysteresis loop. “NY” shown in FIG. 1E signifies neutral or zero states, for example a cancelled gap state alternating between a positive and negative state. In an embodiment, RGB Bit spectral data is mapped using spectral logic according to polarity, flux density, magnetization force, timing and spacing, rotation, and memory states exhibiting a functional curve and the interaction between positive and neutral and negative. The RGB Bit system leverages the full range of the spectral polarity data providing increased mathematical calculations.

Today's computer systems use binary codes for operational instructions, either a signed or unsigned value. A conventional digital binary bit has two states: zero or one which can be described as ground, low, zero voltage potential. The other state can be described as high voltage potential, either on or off. In an embodiment, the RGB Bit System 100 uses an inherent signed value. In an embodiment, a single RGB Bit comprises three binary input channels for one output channel of combined spectral logic programmable functions identified as RGB Bit logic states. For example, a neo pixel, an addressable RGB Bit LED, has a common high 5 voltage anode with a WS2811 address data chip for the RGB Bit grounding paths as the logic states require a voltage for preprogrammed RGB Bit logic states: 0 or −1 for Red, 0 or 1 for Green, and 0 or +1 for Blue or any combination thereof. The combination of these grounding paths creates an analog or digital resolution range based on receiver thresholds. Each channel can be defined with digital thresholds for base number bit resolutions such as octal or hexadecimal bit depth. RGB Bit channels can be controlled with analog variable ranges of value depth building on the binary concept, creating three options in the RGB Bit binary system: +1, 0 and −1. Conventional binary is represented in the color spectrum as either black or white. In an embodiment, by adding a spectrum of informational depth to the black or white, the RGB Bit system 100 expands to multiple layers, depending on whether it is analog or digital, resulting in resolution levels that are expansive variables.

In an embodiment, RGB Bit coding hierarchies are built upon three energetic values (i.e., positive, negative, and neutral), which are the RGB Bit fundamental mathematical base values. Applying color to magnetic theory, as shown in FIG. 1E, blue (on the top right) is 00+, Green (in the middle) is ONO, Red (on the bottom left) is −00, etc. The first, second, and third digits represent the values of the Red component, the Green component, and the Blue component, in that order. The neutral energetic state is described as alternating between the positive and negative as a balanced or steady state. Zero is the absence of an individual magnetic state, a balanced combination of the two forces at different frequencies or concentration depths. As the resolution is increased, the RGB Bit Logic Computation System 100 has unbounded options. As the number of energetic values (i.e., the resolution level) is increased, if it is continuous such as analog, the combinations represent immeasurable possibilities. For example, a motor with a magnetic rotary encoder can reflect the RGB Bit reflected color, with timing and spacing. The reflected light from the color light reflects to the color sensor, which takes the sensor values and sends it to the RGB Bit CPU. The CPU interprets the language through RGB Bit software and outputs to a neo pixel array. In an embodiment, RGB Bit memory circuitry 108 and RGB Bit CPU 110 comprise various types of memory, including at a minimum color and magnetic code. Using various developmental hardware components, the RGB Bit Logic Computation System 100 can create an operational merry go round as an example using color and magnetics FIG. 1B. RGB Bit logic states are identified as individual blocks of color-coded data each operating independently. The RGB Bit Logic Computation System 100 is designed to leverage an energetic RGB Bit event driven state using the color-magnetic spectrum. In an embodiment, an RGB Bit logic state is represented by a color, a magnetic fingerprint, polarity, paths, color hue saturation, patterns, tints and different color memory. The RGB Bit Logic Computation system 100 uses the magnetic color spectrum to create states and algorithms. For example, it will enhance Artificial Intelligence (AI) and quantum computing by deploying the principles of the color-magnetic domains, the magnetic spectrum, not currently used today. In an embodiment, RGB Bit System applications will include encryption systems and educational developmental product prototypes.

Therefore, it can be seen that the system of FIG. 1A stores a predetermined mapping of separate pieces of bit information and data symbols in a first format. Each piece of bit information defines a bit and including (i) at least a color that is based one or more of at least two different colors (such as any two of red, green, or blue) or (ii) at least one of a plurality of magnetic states such as any of the states shown in FIG. 1E. The first format may be binary data in one example, but the present embodiments are not limited as such. For instance, the first format may be any form of quantifiable data known the art, including analog or vector-based features. With the bit mapping scheme defined above, the system can receive data symbols in the first format and output bits based on the stored predetermined mapping.

In an embodiment FIG. 1F shows a series of algorithms that endeavor to recognize underlying relationships in a set of RGB Bit data. Some examples of algorithms or operations shown in FIG. 1F include a buffer (i.e., a YES gate), an inverter (i.e., a NOT gate), an OR gate, an AND gate, floating point, addition and subtraction operations, and multiplication and division operations. For example, −1 times −1 equals a positive +1, further representing the multiplication and division operations, −1 divided by −1 is +1. These examples are not intended to be limiting, and other algorithms or operations (e.g., a NOR gate, a NAND gate, etc.) can be implemented based on the RGB Bit data.

In an embodiment, a neural RGB Bit network FIG. 1G refers to an array of sensors 114. RGB Bit neural networks, for example using weight painting alternating vibrational logic can adapt to changing input and output, for example AI. The RGB Bit network generates the best possible result without needing to redesign the output criteria. The concept of neural networks has its roots in artificial intelligence. For example, the RGB Bit weight painting system triggers a higher red and will register and store a gain value different than the green and blue. In an embodiment, the RGB Bit system 100 accepts information, processes, transmits, and receives simultaneously data using the color magnetic spectrum. Neural networks are swiftly gaining in popularity in the development of trading systems using block chain technology. In an embodiment, the RGB Bit CPU 110 accepts information, processes, and transmits. A neural network is defined as a computer system modeled on the brain and nervous system. It is a computer network architecture consisting of nodes connected to each other by nodes of differing strengths. For example, the input is represented by RGB Bits, the output contains the valuations for hue saturations, brightness, etc. The training of the neural network is based on weight painting, capturing results repeatedly through machine learning to identify the data.

In another example, FIG. 1H shows how RGB Bits can be used to enhance the internal operations of a neural network. For instance, FIG. 1H shows how a convention neural network performs weighting. The nodes in neural networks are composed of parameters referred to as weights used to calculate a weighted sum of the inputs. In the convention neural network, the weights on the connections between nodes are represented by integer values.

However, with RGB Bits, the color values may be used to represent weighting between nodes. The granularity of the weighting can be based on the number of states in the RGB Bit system. One of the main advantages is that by using RGB Bit values for values associated with the nodes of a neural network, a whole new method of storing a neural network based on visible colors, can be achieved.

FIG. 1I shows another way in which neural networks can be used in combination with the above described RGB Bit system. For instance, since color value detection is important for properly detecting data values when using RGB Bits, AI can be used to recognize what specific color is being displayed or transmitted. During training time, a color pixel may be inputted into a deep learning algorithm along with a label indicating what data value (shown here as a binary data value) is being represented by the color.

The inputs are provided to a deep learning algorithm. The deep learning algorithm used may be based on available software as known in the art, such as Tensorflow, Keras, Mxnet, Caffe, or Pytorch. The result of the labeled training will be a neural network. The neural network created includes nodes of each layer are clustered, the clusters overlap, and each cluster feeds data to multiple nodes of the next layer.

The bottom of FIG. 1I shows the usage of the deep learning model after training has reached an adequate level. This is referred to as “inference time” since recommendation will be inferred from input data without a label. It can be seen that the input stage does not include a label of a color pixel value. The inputs are fed to the trained neural network, which will provide an output of the data value that best fits the recognized color. With the neural network model described herein, if color values are not consistent over multiple types of displays, a system can be trained to recognize the RGB Bits even if the displayed color value is not a true color representation.

FIG. 1J shows yet another implementation of RGB Bits to the field of artificial intelligence. For instance, neural networks have multiple applications, such as performing image recognition or speech recognition. However, the types of inputs for these different applications are completely different. Therefore, different types of processing may be needed for each different application. However, RGB Bits can be used to normalize data so that the say type of deep learning algorithm can be used no matter what types of inputs are involved. FIG. 1J shows that image data and speech waveform data can both be translated into RGB Bit data. Then this RGB Bit data can be fed into a neural network, which will perform pattern recognition on the RGB Bit data.

Referring to FIG. 1K, in an embodiment, preprogrammed light enters an RGB Bit borescope and travels through a reflective chamber, subdividing the light which sends the signal back to the fiber optic borescope to a camera color sensor.

Referring to FIG. 1L, conventional computing uses 1 binary state while in an embodiment, RGB Bit computing uses 3 binary states as one.

Referring to FIGS. 1A and 1M, in an embodiment, the RGB Bit system 100 includes circuitry configured to distinguish one RGB Bit logic state 106 from another RGB Bit logic state 106 based upon a detected color or a detected rate of change between colors. Accordingly, in an embodiment, the RGB Bit system 100 includes circuitry configured to enable an eye dropper function to sample any colors of a memory address.

FIG. 1N depicts signed RGB Bit polarity direction, most significant and least significant bit or any combination thereof according to one embodiment.

FIG. 1-O depicts a schematic of fixed and floating point RGB Bit mantissa arithmetic.

Example 1: In an embodiment, the disclosed technologies and methodologies include an RGB Bit Logic Computation System configured to provide a CPU with encryption states with multiple neural simultaneous pathways, providing an effective technology alternative to hashing with an expansive number of algorithms by using magnetic color spectrum technology. In an embodiment, machine learning such as AI (Artificial Intelligence) will be enhanced with the RGB Bit Logic Computation System providing improved accuracy of computations and increased information density, evidencing a full spectrum oscillating magnetic field. It can be used to manifest and improve existing mathematical models of a magnetic and color spectrum oscillating magnetic state concept. In an embodiment, the disclosed technologies and methodologies include generating and storing personal medical RGB Bit data clouds for tracking individual wellness while maintaining the authenticity, confidentiality, and integrity of the personal medical RGB Bit data. In an embodiment, each state represents a time, space and phase array, phase development function, symmetric, asymmetric, color variation etc. which can be manipulated into other states based on color, change in color and predicted next states, etc.

Example 2: In an embodiment, the disclosed technologies and methodologies include RGB Bit systems that improve on current encryption biometrics. Many companies are using biometrics for an additional layer of security as represented by an individual fingerprint. Sensors record certain variations, ridges, and other unique identifying characteristics for password protection. The current biometrics are binary based and limited in processing the full range of biometric application. By contrast, in an embodiment, the RGB Bit system enhances current encryption biometrics by adding both color and polarity to a fingerprint or fingerprints and surrounding areas, making it much more difficult to decipher possible combinations. Colors are converted to states to do calculations, applying function states to biometrics, adding the dimension of color and polarity to make encryption harder to break. In an embodiment, not only is biometrics currently deployed, but the right color and polarity of the RGB Bit System logic will be used for lock and key capabilities. Example 3: In an embodiment, the disclosed technologies and methodologies include improvements to QR code technologies. QR codes currently use binary technology. In an embodiment, by adding the magnetic color spectrum, the color dominance and time dependence of change in color can be varied, for example adding iridescence. In an embodiment, RGB Bit color QR codes can be greatly enhanced by assigning color and an add mix of colors, for example if blue is next to red, put an additional mix of color which makes decryption much more difficult. In an embodiment, another application of RGB Bit processing technology addresses passwords. Traditional passwords are based predominately on the binary system: 1's and 0's, black and white, and therefore can be broken by super computers. In an embodiment, the RGB Bit system contains the complexity of adding the magnetic color spectrum to its range of possible passwords, providing unbounded combinations of lock and key scenarios. In an embodiment, multi-factor authentication using external devices will be improved using the RGB Bit processing software as magnetic spectrum unique passwords using bit depth and polarity will be generated. As passwords will be generated using color and polarity states, eliminating human intervention, ransom ware attacks will be significantly reduced. Passwords as we know them today will be significantly modified, as the lock and key methodology of using unique usernames will contain the password functionality in this RGB Bit embodiment, creating a new variation of traditional QR codes as we know them today into a Dynamic Spectral Quick Response code (DSQR).

Example 4: The RGB Bit generator uses the rasterization process to leverage magnetic spectral fragmented vectors into a set of RGB Bit colors and a single depth value enabling faster programming.

Example 5: The RGB Bit is “The root”. It is the data operating system. All paths stem from the RGB Bit root with our clocking system. It is hierarchical. Folder structures are hierarchical. Admin is like second level; root is top level. Are higher RGB Bits in the hierarchy which will drive the RGB Bits—a location in time and space. The RGB Bit kernel is essentially the operating system. Technically hardware resources are interacting. The apps have no ability to operate independently, have to go through the kernel. The RGB Bit kernel speaks machine language and also interprets the language. The RGB Bit kernel is the operating environment.

In the RGB Bit system, all fields are addressed (+, 0, −) and stem from the root. Every time you do a slash, it is connected to the root of the operating system. The RGB Bit is the root. Need root for every logistical path and program you design. Can have multiple operating systems based on that 1 RGB Bit root.

FIG. 2A depicts a representation and an approach for creating, transmitting, and receiving RGB Bit states 106. In an embodiment, an RGB Bit optocoupler transfers signals through color filters using the magnetic spectrum technology of color and magnetism to transfer signals between two isolated circuits. The illustrated approach includes an opto-coupler, sometimes referred to as an opto-isolator, to transfer electrical signals between two isolated circuits by using light. Opto-isolators prevent high voltages from affecting the RGB Bit system receiving the signal.

FIG. 2AA depicts an example of an RGB Bit impulse generator and RGB Bit receiver computation process. In this embodiment, the RGB Bit 106 is both a frequency generator and receiver. For example, if a camera is pointed at it, the pigment accepts the light, interprets the data and reflects the data in RGB Bits. In this example, a preprogrammed Arduino CPU generates the flow of RGB Bit paths of transmission to receive to the next Arduino generator and transceiver. Using RGB Bit memory 122 an existing Arduino open-source CPU board is configured to include an RGB Bit CPU 110, one or more RGB Bit transmitters 116, RGB Bit receivers 118, or RGB Bit transceivers, as well as the accompanying Arduino CPU. In an embodiment, the Arduino CPU sends a preprogrammed RGB Bit to the transmitter, which is transmitted and interpreted with timing and synchronization, for example, on a preprogrammed quantum dot. Using timing and spacing, the RGB Bit CPU cycles in a feedback loop changing timing and spacing. The microprogrammed information is sent via the transmitter 110. Another Arduino is hooked up to the original Arduino and accepts and interprets the information. In an embodiment, in an RGB Bit system 100, the RGB Bit system makes a transition from one state to another prescribed state based upon the color-magnetic spectral state, defining a change, and emulating alternating magnetic spectral logic.

Arduino has software to take C++ and burn an image on to a CPU, inserting the code image to conform to the pins of the input/output structure. The Arduino CPU is a programmable executable instruction set allowing arithmetic functions and other functions including input/output instructions. In an embodiment, the software is an operating programmable program on top of the hardware which can be adapted to RGB Bit functionality.

In an embodiment, a single RGB Bit 104 comprises three binary input channels for one output channel of combined resolution (digital and analog) spectral logic programmable functions identified as RGB Bit logic states 106.

In an embodiment, the RGB Bit CPU 110 includes circuitry configured to generate an RGB Bit color representation responsive to one or more inputs or outputs indicative of a positive state, neutral state, or a negative state.

FIG. 2B shows a hexagonal data polarity packing topology geometrical array of RGB Bit transmitters 116, RGB Bit receivers, or RGB Bit transceivers forming part of RGB Bit logic circuit. A hexagon shown in FIG. 2B is a structure representing an efficient use of timing and spacing. It depicts the path of least resistance in a balanced field and density, providing more surface area in a most efficient manner, using the least number of components necessary, i.e., a reduction in circuit chips. In an embodiment, an RGB Bit logic 112 circuit is configured to represent an energetic event-driven system in which the RGB Bit system makes a transition from one prescribed state to another prescribed state, provided that the condition defining a change is emulating alternating spectral signals. Different signals can be spaced and combined for new outputs or leveraged data pathing.

FIG. 2C is a schematic diagram of an RGB Bit 104 in the form of a geometric sphere clock mapping synchronization of timing and spacing, and input, output signal clocking and counting 100. It represents an RGB Bit geometric sphere of RGB Bit state typology mapping.

FIG. 2D shows an example of an RGB Bit system's 100 mapping of a binary-logic-based ASCII character code to RGB-Bit-logic-based ASCII character code. In one embodiment, this representation table from a conventional ASCII system to an RGB Bit system 100 exhibits the basic relationship between inputs and outputs building upon the basic RGB Bit code blocks. Conventional data is created, transmitted, and received based upon a binary coding system using the ASCII standard of zeroes and ones (0's and 1's). ASCII, (American Standard Code for Information Interchange), is a character encoding standard for electronic communication. ASCII codes represent text in computers, telecommunications equipment, and other devices. By comparison, the RGB Bit system 100 uses color and magnetism, and other embodiments to create, transmit and receive data incorporating the three states of +1, 0 and −1. In one embodiment, it reflects a schematic diagram of an RGB Bit impulse generator and receiver process showing a flow diagram of a method using a modified Arduino CPU board to create, transmit and receive states. An RGB Bit logic state system represents an energetic event-driven system. In an event-driven system, the RGB Bit system makes a transition from one state to another prescribed state, provided that the condition defining a change is emulating alternating spectral logic: positive, neutral, and negative.

FIG. 2E shows in part an RGB Bit data impulse, reflecting the synchronization of timing and spacing, and input/output signal clocking using an RGB Bit laser with fiber optic pathing and light sensor arrays. It also shows how different signals can be spaced and combined for new outputs or leveraged data pathing. Both an RGB Bit laser and an RGB Bit LED FIG. 2A, can be used interchangeably.

FIG. 2F represents alternating color logic polar coordinates vibrational logic rotating color or color phases as evidenced by RGB Bit temporal variables reflecting variations of existing states. In one embodiment, FIG. 2G reflects RGB Bit alternating color temporal variables showing inverting variables: i.e. oscillating magnetic color spectrum states.

FIGS. 2F and 2G show that the system described above can receive separate pieces of bit information and data symbols in a first format, each piece of bit information defining a bit and including at least a color that is based one or more of at least two different colors; and can control an output of the bits as a physical change or oscillation of an element in time and space. For instance, the separate pieces of bit information are separate pieces of RGB (red, green, and blue) Bit information, each piece of RGB Bit information defining an RGB Bit and including at least a color that is a based on a red, green, or blue color values; and the processing circuitry is configured to control output of the RGB Bits as emissions of color in time and space as shown in FIGS. 2F and 2F.

In such a system, there is at least one light source configured to output emissions of any of red, green, and blue color values. It can be seen that the red, green, or blue color values may be a single color that represents a blended combination of either red, green, or blue, the single color for the RGB Bit simultaneously conveys polarity information that represents a position of the respective RGB Bit with respect to an origin in space, and the phase information that represents a position of the respective RGB Bit in time. The at least one light source is configured to control emission of the RGB Bits based on the polarity information and the phase information.

In this system, the at least one light source includes at least two of a red light emitter, a green light emitter, and a blue light emitter that are configured to emit, in a two-dimensional plane, separate circles of red, green or blue light that intersect at the origin and multiple locations representing combinations of two of red, green, and blue. It can be seen that the emission by the at least two of the red light emitter, the green light emitter, and the blue light emitter in the temporal plane is sinusoidal with different phases, and the processing circuitry is configured to modulate emission of the at least two of the red light emitter, a green light emitter, and a blue light emitter to convey the RGB Bits at separate instances of time.

To achieve the result of FIGS. 2F and 2G, the at least two of the red light emitter, a green light emitter, and a blue light emitter may be generated by a display screen having a pixel array (such as LCD, OLED, plasma, etc.) that includes an array of pixels. In other words, the circular sinusoidal waveform can be generated in virtual 3D environment on the computer system, with the view of this environment being a direct view at the origin.

For example, FIG. 2H shows that while the light emission from three different color light sources may appear as three circles from a “front” view of the light emission at view 2001, when the perspective is changed in the virtual 3D environment, as seen at view 2002, 2003, and 2004, the sinusoidal nature of the waveforms along the temporal axis becomes more apparent.

Alternatively, the at least two of the red light emitter, a green light emitter, and a blue light emitter are generated by mechanically rotating the at least two of the red light emitter, the green light emitter, and the blue light emitter in space. This can be accomplished with a combination of LED light sources and servo motors, as is understood in the art.

FIG. 3A shows in part an RGB Bit hysteresis magnetic core memory using a Hall effect sensor to distinguish a positive, negative, or neutral. The RGB Bit system 100 leverages a color memory circuitry configured to write, read, and store data in an RGB Bit logic state. The RGB Bit is variable memory, the timing and spacing impulse receiving and transmitting. The RGB Bit memory circuitry shows the RGB Bit state and its location in timing and space, based off of resolution values, demonstrating the resolution and expansion of more depth and resolution showing more timing and spacing locations for the memory. The RGB bit memory can be modeled into any geometric configuration, exhibiting more timing and spacing locations for the memory, reflecting the geometry of memory.

In an embodiment, an RGB Bit hysteresis magnetic core memory uses a Hall effect sensor to distinguish a positive flux, negative or neutral flux using a magnetic hysteresis memory state. In an embodiment, the RGB Bit code is designed to set up a program and initialize the memory. The software has triggering events, which sets in motion the Hall effect, for example, the current on a flat piece of copper. If a magnet is introduced to it, it will move the energy to one side. The magnet will spin the current to a higher state on one side or the other, which triggers the storage of the memory. It can also be leveraged for other functions. In an embodiment, RGB Bit data is sensed and interpreted.

FIG. 3B is a schematic diagram of RGB Bit memory locations in timing and spacing of RGB Bit memory. In an embodiment, it shows a color RGB Bit QR code and predefined positions for RGB Bit storage of data: read, write, timing, spacing according to one embodiment.

FIG. 3C is a schematic diagram representing an RGB Bit superposition and entanglement neural network. Quantum entanglement is the phenomena where a pair of particles are generated in such a way that the individual quantum states of each are undefined until measured and the action of measuring one determines the action of the other. Superposition is the ability of a quantum system to be in multiple states at the same time until it is measured. The RGB Bit neural network is a schematic diagram of RGB Bit memory showing a state and its location in timing and spacing, based upon resolution value: for example, a hexadecimal memory grid according to one embodiment. The neural network is a CPU, and the RGB Bit is variable memory, exhibiting the magnetically signed data type for mathematical functionality spectral data polarity packing. FIG. 3C shows the state and its location in timing and spacing based around resolution value depth. Timing is the functionality of the algorithm. The grid exhibits entanglement and super positioning. The resolution and expansion are shown, providing more depth and resolution, more timing and spacing locations for the memory. FIG. 3B exhibits the geometry side of memory including hue saturation values. In an embodiment, the RGB Bit memory 122 can be modeled into a sphere, a cone or any geometric form. In an embodiment, RGB Bit memory 122 characteristics include timing and spacing impulse, receiving or transmitting.

FIG. 3D represents spectral quantum RGB Bit memory dots on a compact disk (CD) or other memory devices. Spectral quantum RGB Bit memory is depicted showing polarity packing, optimizing timing and spacing location efficiency. As shown on the compact disk, a magnetic dot represents the memory, showing that the RGB Bits can be written or read based on timing and spacing.

FIGS. 3C and 3D reflect examples of preprogrammed color geometric grids according to different embodiments. In particular, FIG. 3D represents a sunflower pattern that may be arranged according to the “golden ratio.”

FIG. 3E shows an RGB Bit CPU 110. A conventional CPU is a small computer on a single metal-oxide-semiconductor VLSI integrated circuit chip, a CPU along with memory and programmable input/output peripherals. It is an integrated circuit that contains a CPU along with memory and associated circuits and that controls some or all of the functions of an electronic device comprising the electronic circuitry that executes instructions comprising a computer program. A conventional CPU performs basic arithmetic, logic, controlling, and input/output (I/O) operations specified by the binary instructions in the program. In an embodiment, an RGB Bit CPU 110 includes circuitry configured to compute RGB Bit logic states 112 responsive to integration of at least one RGB Bit 104 and determine a color-magnetic state associated with at least one RGB Bit 104. In an embodiment, this contrasts with external components such as main memory and I/O circuitry, and specialized CPUs such as graphics processing units (GPUs). In an embodiment, the RGB Bit CPU 110 includes conventional CPU components 110 and executes instructions using RGB Bits comprising a computer system using such embodiments as the magnetic spectrum including spectral colors, polarity, magnetic imagery, patterns, hue saturation, tints, distances and creates a color distribution instruction set. Each represents a different color or polarity with timing and spacing. An example is FIG. 2A, the Arduino CPU chip open-source architecture. The RGB Bit CPU includes circuitry configured to compute RGB Bit logic responsive to integration of at least one RGB Bit and determine a magnetic color state associated with at least one RGB Bit to provide RGB Bit logic computation that is programmable. In the RGB Bit Logic Computation system, this also allows the creation of individual programs to control the execution of instructions. In one embodiment, using the RGB Bit software, the RGB Bit CPU 110 instructs the RGB Bit hardware main memory, control unit, ALU and batches instructions using RGB Bits to fetch, decode, execute, and store memory. It decodes information from RAM and goes back to the ALU to store back in RAM.

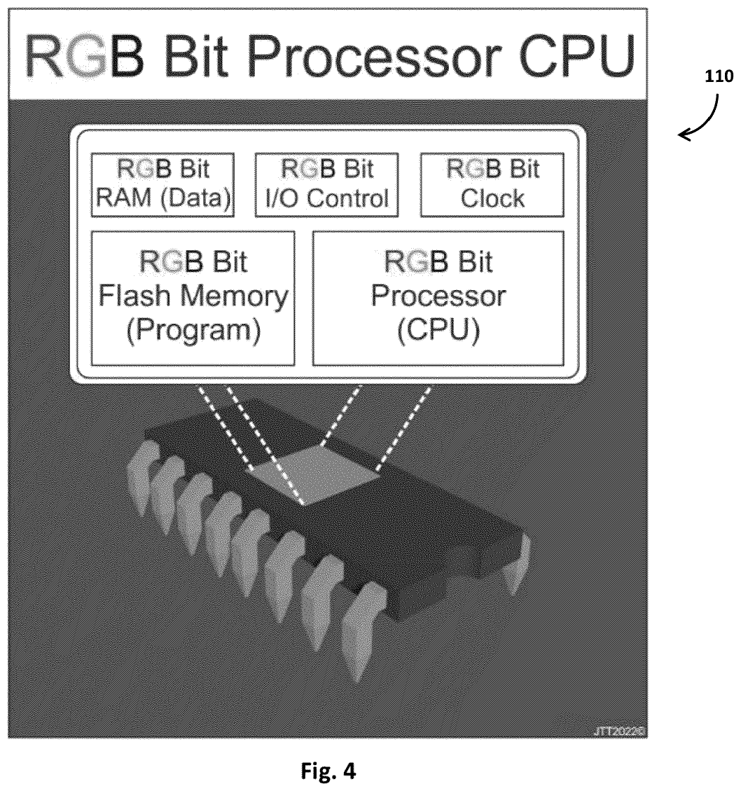

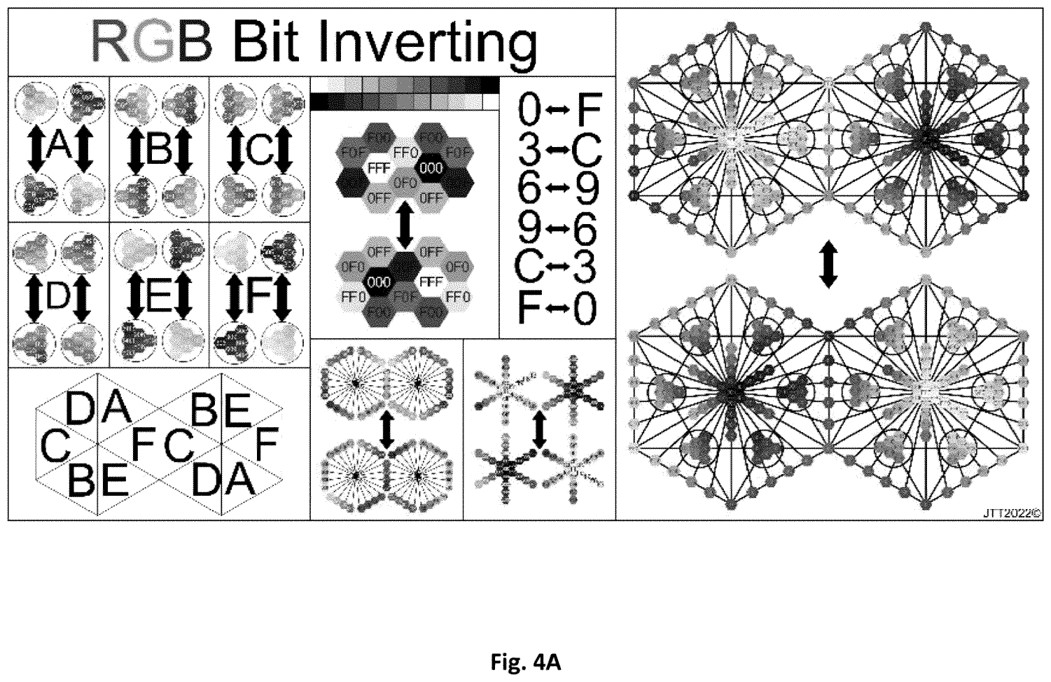

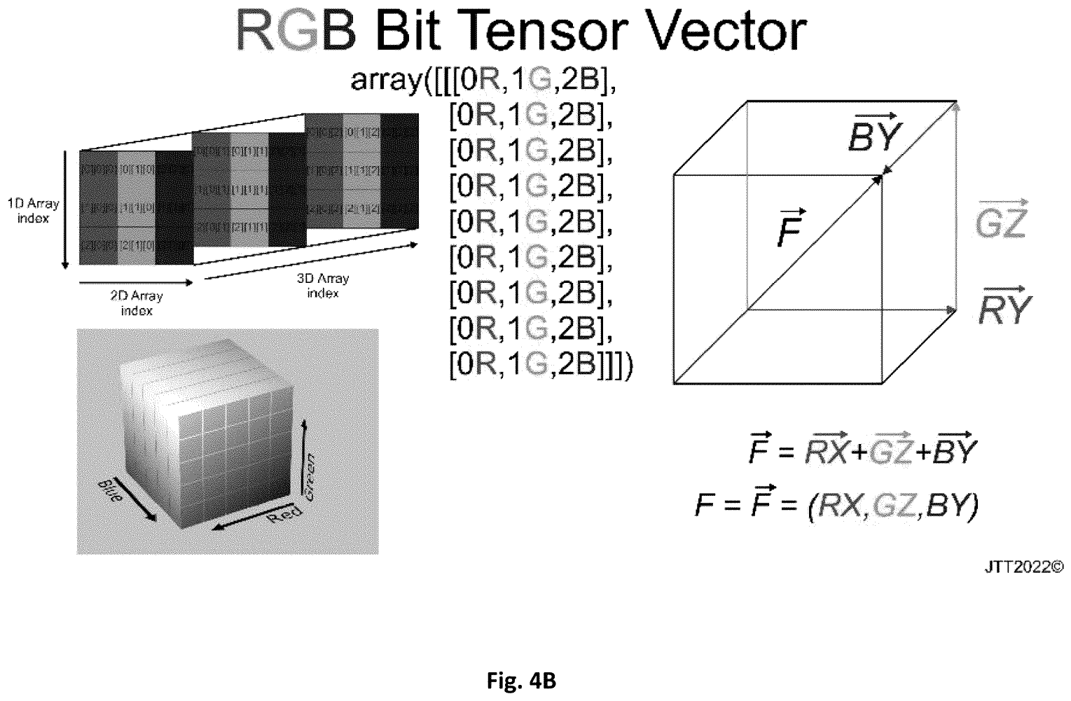

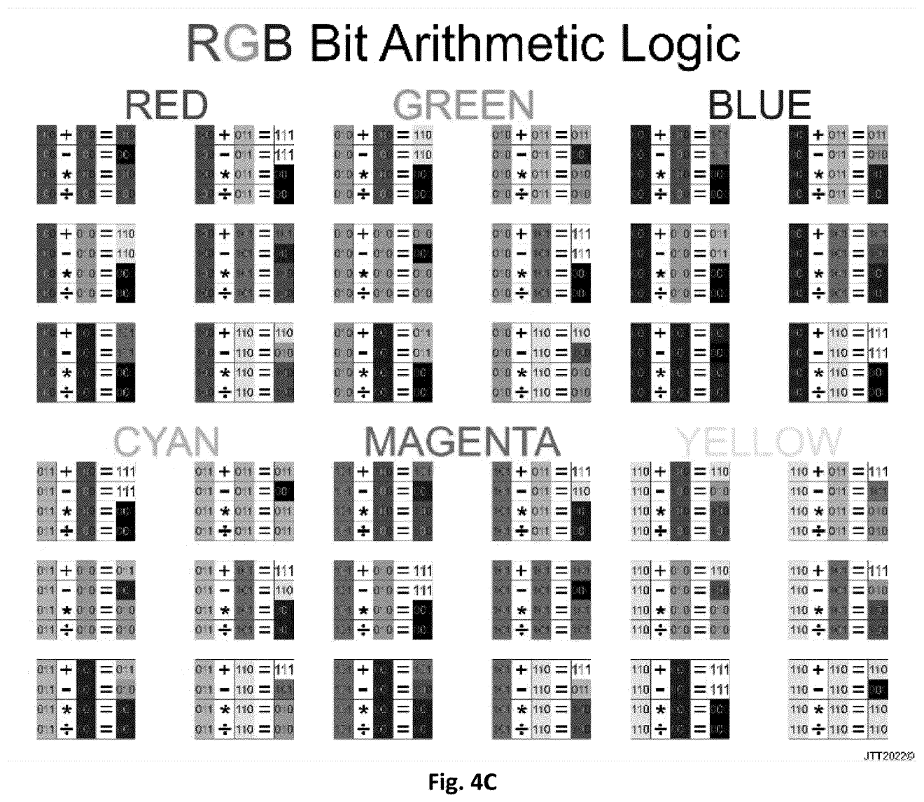

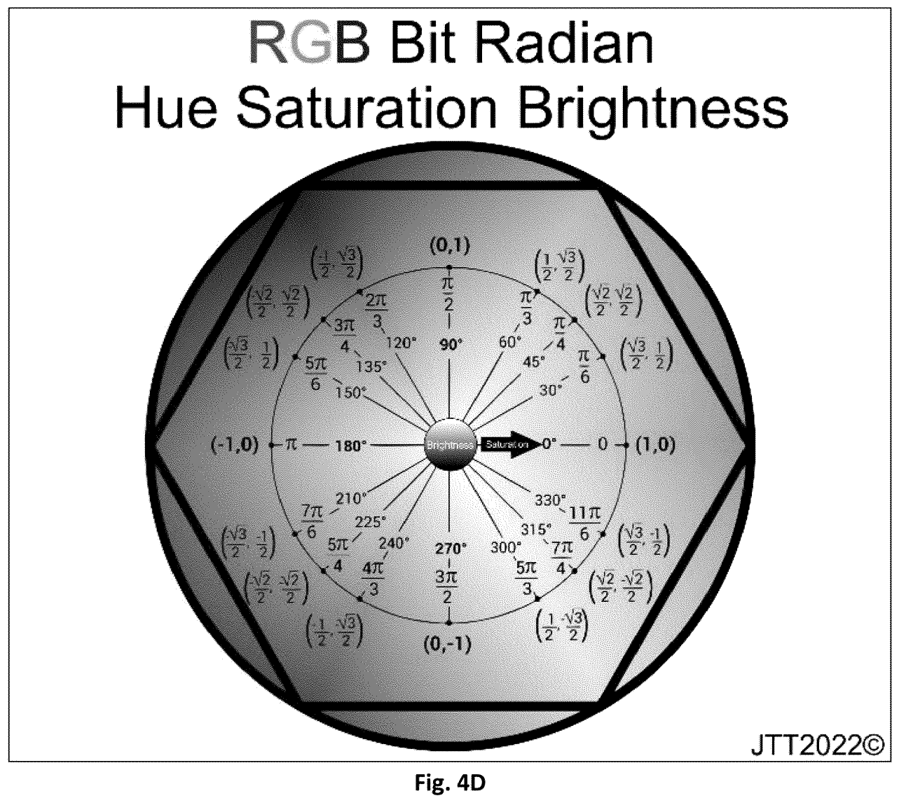

FIG. 4A shows the magnetic color domain topology displaying inverting signals. In an embodiment, an RGB Bit 104 is both an RGB Bit transmitter and RGB Bit receiver representing locations where memory can be stored or restored. FIG. 4A is an example of an RGB Bit CPU 110 and illustrates depth and value. In an embodiment, the RGB Bit CPU 110 is configured to have multiple different pathways traveling through the RGB Bit CPU at the same timing and spacing and represents the RGB Bit neural network. The magnetics have different domains in timing and spacing

FIG. 4B is a schematic diagram of a magnetic color domain topology showing the RGB Bit vector space exhibiting scalers, which can be just an RGB Bit 104 acting as scalers, vectors, matrixes, tensors, and multidimensional tensor arrays. In an embodiment, the RGB Bit is a multi-dimensional sensor matrix array when expanded with the ability to expand to a multidimensional tensor. A multidimensional tensor includes a spaced apart sensor array forming regular or irregular geometric patterns. This represents a neural network. In an embodiment, the RGB Bit 104 is both a transmitter and a receiver reflecting multiple locations where memory can be stored or restored showing both depth and value. In an embodiment, the RGB Bit CPU 110 has the ability to have all the different pathways traveling through the RGB Bit CPU 110 at the same timing and spacing. Spectral magnetics have different domains in timing and spacing. In an embodiment, the RGB Bit technology represents the quantum qubit of the future.

FIG. 4C shows an example of color arithmetic, combinational logic of an RGB Bit system 100, deploying Boolean logic in calculations. The OR gate is addition and subtraction, the AND gate is multiplication and division, and NOT gate is the inversion.

In an embodiment, FIG. 4D represents hue saturation brightness radians, a unit of angle equal to an angle at the center of a circle whose arc is equal in length to the radius. In an embodiment, the RGB Bit memory 122 can be modeled into a sphere or cone or any geometry. The RGB Bit can fill the volume of any given geometry or the surface area of any given geometry. It is an elastic geometric architectural data typology. In an embodiment, RGB Bit memory 122 is characterized by timing and spacing impulses for receiving or transmitting. In this example, the radian was applied to hue saturation brightness using the RGB Bit technology.

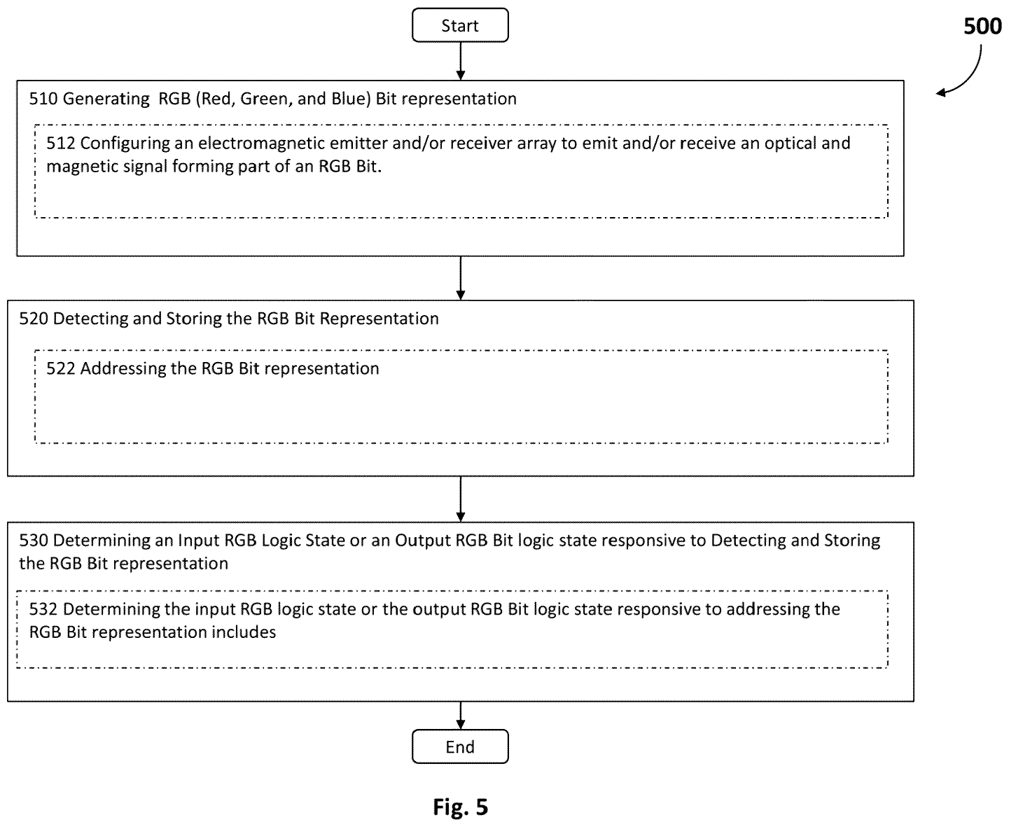

FIG. 5 depicts an overview diagram 500 for identifying the methods of the RGB Bit Logic System. At 510 the method 500 includes generating an RGB (Red, Green, and Blue) Bit representation. At 512, generating the RGB Bit representation includes configuring an electromagnetic emitter and/or receiver array to emit and/or receive an optical and magnetic signal forming part of an RGB Bit. In an embodiment, the RGB Bit system includes a color generating device which identifies color spectral and magnetic bits entitled RGB Bits. In an embodiment, an RGB Bit Generator 102 creates individual bits using colors and magnetic states. In an embodiment, in an RGB Bit event driven system, the RGB Bit system makes a transition from one state to another prescribed state based upon the color-magnetic spectral state, defining a change, and emulating alternating magnetic polarity logic: positive, neutral, and negative.

In an embodiment, at 520 the method 500 includes detecting and storing the RGB Bit representation. In an embodiment, method 500 includes detecting and storing the RGB Bit representation using memory circuitry and the RGB Bit CPU 110. In an embodiment, the RGB Bit CPU 110 and register know where the data is stored as a means for generating RGB Bit addressing information. In an embodiment, the RGB Bit CPU 110 uses a combination of hardware and software components, including a description and the algorithms it uses, and leverages when to use it. An example is a CD that has micro dots of RGB Bits with correct timing and spacing. Normal CDs use a laser, using a dot or no dot. In an embodiment, the RGB Bit Compact Disk uses RGB Bit quantum dots to store magnetic states in a location on the CD using timing and spacing. At 522, detecting and storing the RGB Bit representation includes addressing the RGB Bit representation. In an embodiment, an RGB Bit generator 102 creates individual bits using colors and magnetic states. In an embodiment, in an RGB Bit event driven system, the RGB Bit system makes a transition from one state to another prescribed state based upon the color-magnetic spectral state, defining a change, and emulating alternating magnetic polarity logic: positive, neutral, and negative.

In an embodiment, at 530 the method 500 includes determining an input RGB Bit logic state or an output RGB Bit logic state responsive to addressing the RGB Bit representation. At 532, determining an input RGB Bit logic state or an output RGB Bit logic state responsive to addressing the RGB Bit representation includes determining the input RGB Bit logic state or the output RGB Bit logic state responsive to addressing the RGB Bit representation. In an embodiment, an RGB Bit CPU 110 computes RGB Bit logic responsive to at least one RGB Bit and determines a magnetic state associated with at least one RGB Bit. It includes circuitry configured to generate an RGB Bit color representation responsive to one or more inputs indicative of a positive state, neutral state, or a negative state. The RGB Bit system addresses quantum computing and artificial intelligence using modulation and coding. The code that controls the quantum coding is an energetic value system. Current quantum computing is not deploying the principles of magnetic spectral domains or energetic values in the same way.

In an embodiment, generating the RGB Bit representation includes detecting an optical and magnetic signal from an electromagnetic emitter/receiver array and generating the RGB Bit representation. In an embodiment, generating the RGB Bit representation includes emitting or receiving an optical and magnetic signal forming part of an RGB Bit.

In an embodiment, detecting and storing the RGB Bit representation includes addressing the RGB Bit representation. In an embodiment, a CPU addresses the RGB Bit representation and wherein determines an input RGB Bit logic state or an output RGB Bit logic state responsive to detecting and storing the RGB Bit representation.

In an embodiment, generating the RGB Bit representation includes generating individual RGB Bits using colors and magnetic states. In an embodiment, generating the RGB Bit representation includes generating an RGB Bit color representation responsive to one or more inputs indicative of a positive state, neutral state, or a negative state. In an embodiment, an RGB Bit Generator creates individual bits using colors and magnetic states. In an RGB Bit event driven system, the RGB Bit system makes a transition from one state to another prescribed state based upon the color-magnetic spectral state, defining a change, and emulating alternating magnetic polarity logic: positive, neutral, and negative.

In an embodiment, determining the input RGB Bit logic state or the output RGB Bit logic state responsive to addressing the RGB Bit representation includes an RGB Bit CPU: the RGB Bit system includes a color central processing unit to compute RGB Bit logic responsive to at least one RGB Bit and determines a magnetic state associated with at least one RGB Bit. It includes circuitry configured to generate an RGB Bit color representation responsive to one or more inputs indicative of a positive state, neutral state, or a negative state. In an embodiment, the RGB Bit system addresses quantum computing and artificial intelligence using modulation and coding. The code that controls the quantum coding is an energetic value system. Current quantum computing is not deploying the principles of magnetic spectral domains or energetic values in the same way.

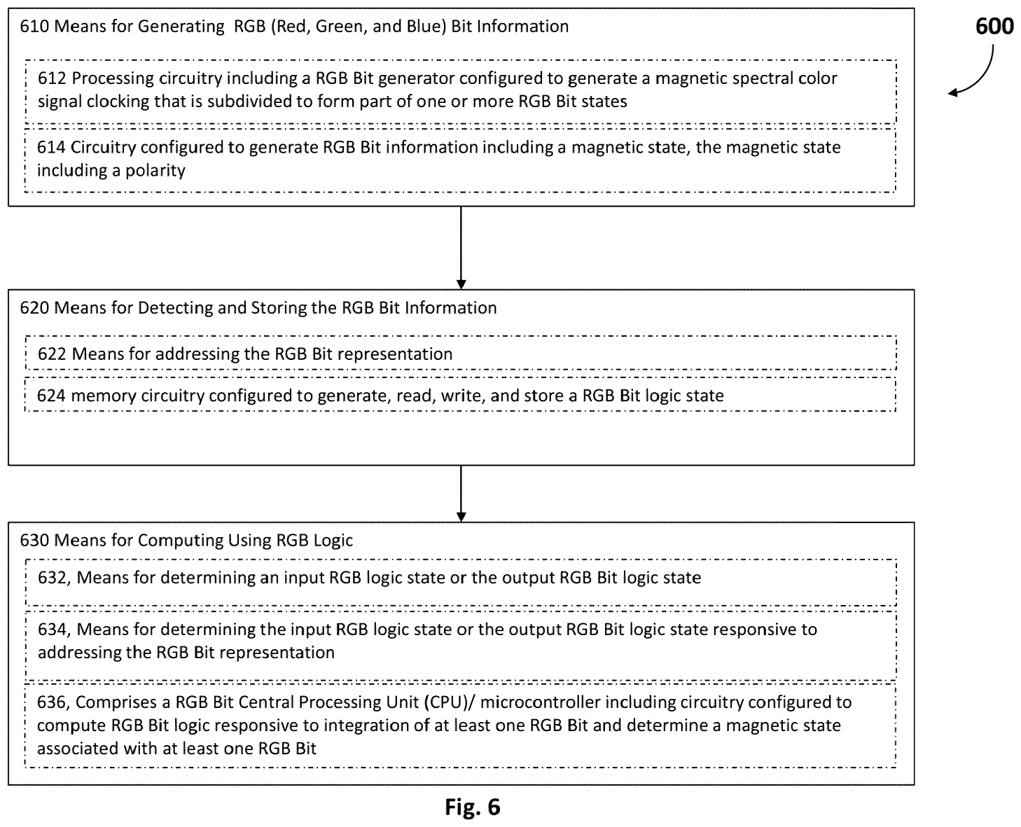

FIG. 6 shows an RGB Bit Logic Computation System 600 in which one or more of the disclosed methodologies or technologies can be implemented such as, generating, storing, or processing data using RGB Bits bit logic. In an embodiment, the RGB Bit Logic Computation System 600 includes means 610 for generating RGB Bit information. In an embodiment, the algorithms of the RGB Bit Logic computing system respond to a request for a process, and the need to form a calculation. In an embodiment, the means 610 for generating RGB Bit information comprises processing circuitry 612 including an RGB Bit Generator 102 configured to generate a magnetic spectral color signal clocking that is subdivided to form part of one or more RGB Bit logic states 106. In an embodiment, the means 610 for generating RGB Bit information comprises processing circuitry 614 configured to generate RGB Bit information including a magnetic state, the magnetic state including a polarity responsive to one or more inputs indicative of a detected RGB Bit state.

In an embodiment, the means 610 for generating RGB Bit information comprises processing circuitry configured to generate magnetic states including a polarity responsive to one or more inputs indicative of RGB Bit logic computation. Triggering the RGB Bit CPU representation includes configuring an electromagnetic emitter and/or receiver array to emit and/or receive an optical and magnetic signal forming part of an RGB Bit. In an embodiment, the RGB Bit system includes in the CPU a color generating device which identifies color spectral and magnetic bits entitled RGB Bits. In an embodiment, an RGB Bit Generator creates individual bits using colors and magnetic states. In an embodiment, in an RGB Bit event driven system, the RGB Bit system makes a transition from one state to another prescribed state based upon the color-magnetic spectral state, defining a change, and emulating alternating magnetic polarity logic: positive, neutral, and negative. For example, the RGB Bit generator using an Arduino board represents an oscillator tuning fork. When it is turned on, it creates an AC signal. Electro striction, a voltage applied to the crystal electrodes causes it to change shape. When the voltage is removed, the crystal generates a small voltage as it elastically returns to its original state. The closing provides the hierarchical timing, which can be multiplied or divided to provide commands to go faster and slower, but it is still based on the resonance gap. The RGB Bit Generator provides a stable signal similar to a Piezo crystal electric resonator which causes it to change state. When removed, it creates a small voltage that ultimately is returned to its original state.

In an embodiment, with reference to FIG. 6, an RGB Bit Logic Computation system 600 includes means 620 for detecting and storing the RGB Bit information. In an embodiment, the means 620 for detecting and storing the RGB Bit information comprises a memory circuitry 622 configured to generate, read, write, and store an RGB Bit logic state. FIG. 2A exhibits the triggering of an RGB Bit information storing event, the functions and the RGB Bit combinational logic magnetic arithmetic state. In an embodiment, the means 620 for detecting and storing the RGB Bit information comprises a memory circuitry 624 including one or more light-emitting diodes, laser diodes, microcavity light-emitting diodes, organic light-emitting diodes, polymer light-emitting diodes, polymer phosphorescent light-emitting diodes, or high-efficiency light-emitting diodes forming part of an input RGB Bit logic state or an output RGB Bit logic state.

In an embodiment, the means 620 for detecting and storing the RGB Bit information comprises one or more fiber lasers, lasers, or ultra-fast lasers forming part of an input/output RGB Bit logic state or an output RGB Bit logic state. In an embodiment, the means 620 for detecting and storing the RGB Bit information comprises an RGB Bit color light sensor timing identifying it as its own RGB Bit magnetic spectral memory state and the changes, timing, spacing, frequencies or alternating color polarities. In an embodiment, the means 620 for detecting and storing the RGB Bit information comprises a processor coupled to an RGB Bit memory circuitry configured to change a color to a preprogrammed color geometric grid responsive to one or more inputs/outputs indicative of a color and magnetic change. In an embodiment, the means 620 for detecting and storing the RGB Bit information comprises a processor coupled to RGB Bit memory circuitry, configured to change an RGB Bit pixel array from a first pixelated color distribution to a second pixelated magnetic emulated color distribution, different from the first.

In an embodiment, the RGB Bit Logic Computation System includes means 630 for computing using RGB Bit logic. In an embodiment, the means 630 for computing using RGB Bit logic comprises an RGB Bit Central Processing Unit (CPU) 110 including circuitry configured to compute RGB Bit logic responsive to integration of at least one RGB Bit and determine a magnetic state. In an embodiment, the means 630 for computing using RGB Bit logic comprises an RGB Bit CPU including circuitry configured to generate an RGB Bit color representation responsive to one or more inputs or outputs indicative of a positive state, neutral state, or a negative state.

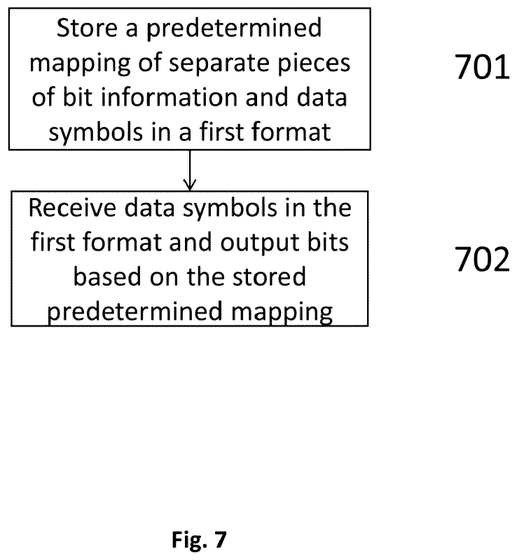

FIG. 7 shows a method performed by embodiments described above. For instance, FIG. 7 relates to a method performed by the system depicted in FIG. 1A. In step 701, the processing circuitry of the system stores a predetermined mapping of separate pieces of bit information and data symbols in a first format. For instance, each piece of bit information defines a bit and including (i) at least a color that is based one or more of at least two different colors or (ii) at least one of a plurality of magnetic states. In step 702, the processing circuitry of the system receives data symbols in the first format and output bits based on the stored predetermined mapping.

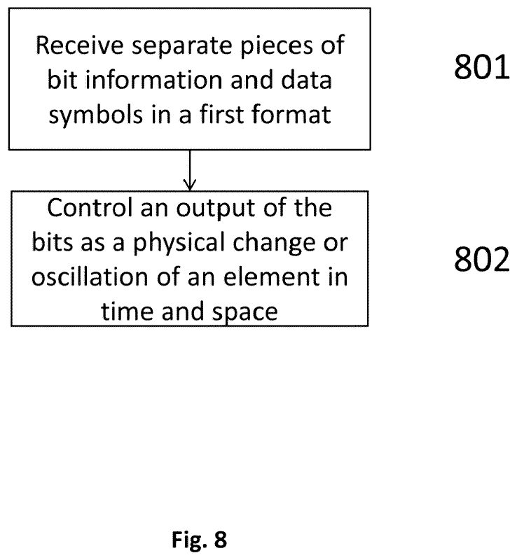

FIG. 8 shows another method performed by embodiments described above. For instance, FIG. 8 relates to a method performed by the system features depicted in FIG. 2F. In step 801, the processing circuitry of the system receive separate pieces of bit information and data symbols in a first format. For instance, each piece of bit information defining a bit and including at least a color that is based one or more of at least two different colors. In step 802, the processing circuitry of the system controls an output of the bits as a physical change or oscillation of an element in time and space.

In a general sense, the various systems, devices, methods, technologies, methodologies, and the like described herein can be implemented by diverse types of electrical circuitry having a wide range of components, hardware, firmware, software, drivers, utilities, electrical components, electro-optical components, electro-mechanical components, and combinations thereof.

Examples of electrical circuitry (e.g., computational circuitry, processing circuitry, control circuitry, and the like.) include application specific integrated circuits, discrete electrical circuits, integrated circuits, and the like.

In an embodiment, electrical circuitry includes, among other things, one or more computing devices such as a processor (e.g., a microprocessor), a central processing unit (CPU), a digital signal processor (DSP), an application-specific integrated circuit (ASIC), a field programmable gate array (FPGA), or the like, or any combinations thereof, and can include discrete digital or analog circuit elements or electronics, or combinations thereof. In an embodiment, electrical circuitry includes one or more ASICs having a plurality of predefined logic components. In an embodiment, electrical circuitry includes one or more FPGA having a plurality of programmable logic components.

In an embodiment, electrical circuitry includes one or more electrical components operably coupled (e.g., communicatively, electromagnetically, magnetically, ultrasonically, optically inductively, electrically, capacitively coupled, and the like) to each other. In an embodiment, electrical circuitry includes one or more remotely located components. In an embodiment, remotely located components are operably coupled via wireless communication. In an embodiment, remotely located components are operably coupled via one or more receivers, transceivers, or transmitters, antennas, or the like.

In an embodiment, electrical circuitry includes one or more network elements. Non-limiting examples of network elements include Local Area Networks (LANs), network gateway systems, network usage servers, Wide Area Networks (WANs), wireless base stations, wireless relays, and the like. In an embodiment, electrical circuitry includes computer and communication platforms that include data Input/Output (I/O) transceivers, digital processing circuitry, data storage memories, various software components, and the like.

In an embodiment, electrical circuitry includes one or more memory devices that, for example, store instructions or data. The RGB Bit system 100 includes one or more memory devices storing user-specific sustainability information, user-specific carbon footprint information, enterprise-wide sustainability information, or enterprise-wide carbon footprint information with a remote client device and remote server. Non-limiting examples of one or more memory devices include volatile memory (e.g., Random Access Memory (RAM), Dynamic Random-Access Memory (DRAM), or the like); non-volatile memory (e.g., Read-Only Memory (ROM), Electrically Erasable Programmable Read-Only Memory (EEPROM), Flash memory, or the like); persistent memory; or the like. The one or more memory device can be coupled to, for example, one or more computing devices by one or more instructions, data, or power buses.

In an embodiment, examples of sensors 114 include anything that converts optical, electro optical, transducers, magnetic states of a signal into a signal and the like. Included are CDs and cameras. A magnetic hard disk is a storage device that uses a magnetization process to write, rewrite, and access data via a magnetic hysteresis flux density and magnetization force. In an embodiment, the RGB Bit memory is the hard drive in the RGB Bit CPU. The RGB Bit CPU is able to magnetize in different directions converting optical to electrical energy.

In an embodiment, electrical circuitry includes one or more computer-readable media drives, interface sockets, Universal Serial Bus (USB) ports, memory card slots, or the like, and one or more input/output components such as, for example, a graphical user interface, a display, a keyboard, a keypad, a trackball, a joystick, a touchscreen, a touch-sensitive display, a mouse, a switch, a dial, or the like, and any other peripheral device. In an embodiment, electrical circuitry includes one or more user input/output components that are operably coupled to at least one computing device to control (electrical, electromechanical, software-implemented, firmware-implemented, or other control, or combinations thereof) at least one parameter associated with, for example, generating a user interface presenting a rating menu and receive one or more inputs indicative of a rating associated with the event based on the rating menu.

In an embodiment, electrical circuitry includes a computer-readable media drive or memory slot that is configured to accept signal-bearing medium (e.g., computer-readable memory media, computer-readable recording media, or the like). In an embodiment, a program for causing a system to execute any of the disclosed methods can be stored on, for example, a computer-readable recording medium (CRMM), a signal-bearing medium, or the like. Non-limiting examples of signal-bearing media include a recordable type medium such as a magnetic tape, floppy disk, a hard disk drive, a Compact Disc (CD), a Digital Video Disk (DVD), Blu-Ray Disc, a digital tape, a computer memory, or the like, as well as transmission type medium such as a digital and/or an analog communication medium (e.g., a fiber optic cable, a waveguide, a wired communications link, a wireless communication link (e.g., receiver, transceiver, or transmitter, transmission logic, reception logic, etc.). Further non-limiting examples of signal-bearing media include, but are not limited to, DVD-ROM, DVD-RAM, DVD+RW, DVD-RW, DVD-R, DVD+R, CD-ROM, Super Audio CD, CD-R, CD+R, CD+RW, CD-RW, Video Compact Discs, Super Video Discs, flash memory, magnetic tape, magneto-optic disk, MINIDISC, non-volatile memory card, EEPROM, optical disk, optical storage, RAM, ROM, system memory, web server, or the like.

In an embodiment, electrical circuitry includes computing circuitry, memory circuitry, electrical circuitry, electro-mechanical circuitry, control circuitry, transceiver circuitry, transmitter circuitry, receiver circuitry, and the like.

The herein described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include, but are not limited to, physically mate able, physically interacting components, wirelessly interactable, wirelessly interacting components, logically interacting, logically interactable components, etc.

In an embodiment, one or more components may be referred to herein as “configured to,” “configurable to,” “operable/operative to,” “adapted/adaptable,” “able to,” “conformable/conformed to,” etc. Such terms (e.g., “configured to”) can encompass active-state components, or inactive-state components, or standby-state components, unless context requires otherwise.

The foregoing detailed description has set forth various embodiments of the devices or processes via the use of block diagrams, flowcharts, or examples. Insofar as such block diagrams, flowcharts, or examples contain one or more functions or operations, it will be understood by the reader that each function or operation within such block diagrams, flowcharts, or examples can be implemented, individually or collectively, by a wide range of hardware, software, firmware in one or more machines or articles of manufacture, or virtually any combination thereof. Further, the use of “Start,” “End,” or “Stop” blocks in the block diagrams is not intended to indicate a limitation on the beginning or end of any functions in the diagram. Such flowcharts or diagrams may be incorporated into other flowcharts or diagrams where additional functions are performed before or after the functions shown in the diagrams of this application. In an embodiment, several portions of the subject matter described herein are implemented via Application Specific Integrated Circuits (ASICs), Field Programmable Gate Arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors, FPGAs and the like), as firmware, or as virtually any combination thereof, and that designing the circuitry or writing the code for the software and or firmware would be well within the skill of one of skill in the art in light of this disclosure. In addition, the mechanisms of the subject matter described herein are capable of being distributed as a program product in a variety of forms, and that an illustrative embodiment of the subject matter described herein applies regardless of the type of signal-bearing medium used to conduct the distribution. Non-limiting examples of a signal-bearing medium include the following: a recordable type of medium such as a floppy disk, a hard disk drive, a Compact Disc (CD), a Digital Video Disk (DVD), a digital tape, a computer memory, etc.; and a transmission type medium such as a digital or an analog communication medium (e.g., a fiber optic cable, a waveguide, a wired communications link, a wireless communication link (e.g., transmitter, receiver, transmission logic, reception logic, etc.), etc.).

While aspects of the present subject matter described herein have been shown and described, it will be apparent to the reader that, based upon the teachings herein, changes and modifications can be made without departing from the subject matter described herein and its broader aspects and, therefore, the appended claims are to encompass within their scope all such changes and modifications as are within the true spirit and scope of the subject matter described herein. In general, terms used herein, and especially in the appended claims (e.g., bodies of the appended claims) are generally intended as “open” terms (e.g., the term “including” or “among other things” should be interpreted as “including but not limited to,” the term “having” should be interpreted as “having at least,” the term “includes” should be interpreted as “includes but is not limited to,” etc.). Further, if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, such recitation should typically be interpreted to mean at least the recited number (e.g., the bare recitation of “two recitations,” without other modifiers, typically means at least two recitations, or two or more recitations).

Furthermore, in those instances where a convention analogous to “at least one of A, B, and C, etc.” is used, in general such a construction is intended in the sense of the convention (e.g., “a system having at least one of A, B, and C” would include among other things a systems that have A alone, B alone, C alone, A and B together, A and C together, B and C together, and/or A, B, and C together, etc.). In those instances, where a convention analogous to “at least one of A, B, or C, etc.” is used, in general such a construction is intended in the sense of the convention (e.g., “a system having at least one of A, B, or C” would include among other things a systems that have A alone, B alone, C alone, A and B together, A and C together, B and C together, and/or A, B, and C together, etc.). Typically, a disjunctive word or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, the operations recited therein generally may be performed in any order. Also, although various operational flows are presented in a sequence(s), the various operations may be performed in orders other than those that are illustrated or may be performed concurrently. Examples of such alternate orderings include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are not intended to exclude such variants, unless context dictates otherwise.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

### LIST OF REFERENCES (EACH OF WHICH IS INCORPORATED HEREIN BY REFERENCE IN FULL)

1. U.S. Pat. Nos. 2,989,477, 3,161,861, 3,434,775, 3,971,065, 9,332,239, and 9,500,724.
2. US Patent Publication Nos. US20030076056, US20070188759, US20140119691, US20150369883, and US20200379613.
3. Exemplary Embodiment:

Embodiment 1. A system, comprising:
an RGB (Red, Green, and Blue) Bit generator configured to generate RGB Bit information;
an RGB (Red, Green, and Blue) Bit memory circuitry configured to store the RGB Bit information; and
an RGB (Red, Green, and Blue) Bit Central Processing Unit (CPU) operably coupled to the RGB Bit memory circuitry, and the RGB Bit CPU and is configured to compute RGB Bit logic.

Embodiment 2. The RGB Bit system of embodiment 1, wherein the RGB Bit generator is a programmable variable impulse generator, for example an oscillator or opto coupler, generating magnetic spectral color signal clocking, RGB Bit most significant bit and least significant bit, inverting alternating color magnetic spectral signals and rotating temporal variational states.

Embodiment 3. The RGB Bit system of embodiment 1, wherein the RGB Bit generator includes circuitry configured to generate RGB Bit information including a magnetic state.

Embodiment 4. The RGB Bit system of embodiment 3, wherein the magnetic state comprises polarity: a positive state, a neutral state, and a negative state including both odd and even magnetic polarity configurations.

Embodiment 5. The RGB Bit system of embodiment 3, wherein the magnetic state comprises a data path, a collection of functional RGB Bits such as arithmetic logic units or multipliers that perform data processing operations, register information, and the communications protocol transports. A larger data path can be made by joining more than one RGB Bit data path.

Embodiment 6. The RGB Bit system of embodiment 3, wherein the magnetic state comprises RGB Bit spectral radians hue saturation value. Hue is assigning spectral rotation. Saturation is the amplitude of the signal.

Embodiment 7. The RGB Bit system of embodiment 3, where the magnetic state comprises lightness and brightness, a visual perception of the luminance of an object. Lightness is a prediction of how an illuminated color will appear.

Embodiment 8. The RGB Bit system of embodiment 3, wherein the magnetic state comprises chromatic colors and achromatic states, groups of colors and states.

Embodiment 9. The RGB Bit system of embodiment 3, wherein the magnetic state comprises radians, a unit of angle equal to an angle at the vertex center of a circle whose arc is equal in length to the radius.

Embodiment 10. The RGB Bit system of embodiment 3, wherein the magnetic state comprises RGB Bit magnetic vibrational vector equilibriums.

Embodiment 11. The RGB Bit system of embodiment 3, wherein the magnetic state comprises color filters, a photographic filter that absorbs light of certain colors.

Embodiment 12. The RGB Bit system of embodiment 3, wherein the magnetic state includes analog and digital magnetic states having odd and even polarity mathematical and magnetic functions.

Embodiment 13. The RGB Bit system of embodiment 3, wherein the magnetic state comprises RGB Bit variable values. A value is a defined object.

Embodiment 14. The RGB Bit system of embodiment 3, wherein the magnetic state comprises a magnetic RGB Bit hysteresis loop, the dependence of the state of a system on its history.

Embodiment 15. The RGB Bit system of embodiment 3, wherein the magnetic state comprises feedback loops used to control the output of electronic devices.

Embodiment 16. The RGB Bit system of embodiment 3, wherein the wherein the RGB Bit generator includes circuitry operably coupled to a magnet or a component configured to produce a magnetic field.

Embodiment 17. The RGB Bit system of embodiment 1, wherein the wherein the RGB Bit generator comprises prisms with refracting faceted geometric lenses at angles with each other and that separates light into a spectrum of RGB Bit colors.

Embodiment 18. The RGB Bit system of embodiment 1, wherein the RGB Bit generator includes circuitry configured to determine an RGB Bit magnetic spectral state based on feedback loop logic and spectral logic associated with RGB Bit hysteresis magnetic domains.

Embodiment 19. The RGB Bit system of embodiment 1, wherein the RGB Bit generator comprises processing circuitry operably coupled to robotic components, machines, or electromechanical devices configured to carrying out a complex series of actions automatically.

Embodiment 20. The RGB Bit system of embodiment 1, wherein the RGB Bit memory circuitry includes memory circuitry configured to generate, read, write, and store an RGB Bit logic state.

Embodiment 21. The RGB Bit system of embodiment 20, wherein the RGB Bit logic state comprises magnetic memory polarity: a positive state, a neutral state, and a negative state including both odd and even magnetic polarity geometric configurations.

Embodiment 22. The RGB Bit system of embodiment 20, wherein the RGB Bit logic state comprises a memory data path, a collection of functional RGB Bit units such as arithmetic logic units or multipliers that perform data processing operations, register information, and the communications protocol transports. A larger data path can be made by joining more than one RGB Bit data path.

Embodiment 23. The RGB Bit system of embodiment 20, wherein the RGB Bit logic state comprises RGB Bit spectral memory radians hue saturation values. Hue is assigning spectral rotation. Saturation is the amplitude of the signal. The RGB Bit system of embodiment 20, wherein the RGB Bit logic state comprises memory lightness and brightness, a visual perception of the luminance of an object. Lightness is a prediction of how an illuminated color will appear.

Embodiment 24. The RGB Bit system of embodiment 20, wherein the RGB Bit logic state comprises memory chromatic and achromatic colors and states, groups of colors that can create a specific look.

Embodiment 25. The RGB Bit system of embodiment 20, wherein the RGB Bit logic state comprises memory radians.

Embodiment 26. The RGB Bit system of embodiment 20, wherein the RGB Bit logic state comprises RGB Bit memory vibrational vector equilibriums.

Embodiment 27. The RGB Bit system of embodiment 20, wherein the RGB Bit logic states are generated using RGB Bit memory color filters.

Embodiment 28. The RGB Bit system of embodiment 20, wherein the RGB Bit logic state comprises memory prisms with refracting faceted geometric lenses at angles with each other and that separates light into a spectrum of RGB Bit colors.

Embodiment 29. The RGB Bit system of embodiment 20, wherein the RGB Bit logic state comprises RGB Bit analog and RGB Bit digital magnetic states determined by odd and even mathematical magnetic memory functions.

Embodiment 30. The RGB Bit system of embodiment 20, wherein the RGB Bit logic state comprises variable memory values.

Embodiment 31. The RGB Bit system of embodiment 20, wherein the RGB Bit logic state a positive state, a neutral state, or a negative state, and an odd or even magnetic polarity geometric configurations.

Embodiment 32. The RGB Bit system of embodiment 20, wherein the RGB Bit logic state comprises a memory data path, a collection of functional RGB Bit units such as arithmetic logic units or multipliers that perform data processing operations, register information, and the communications protocol transports. A larger data path can be made by joining more than one RGB Bit data path.

Embodiment 33. The RGB Bit system of embodiment 20, wherein the RGB Bit logic state comprises RGB Bit spectral memory radians hue saturation values. Hue is assigning spectral rotation.

Embodiment 34. The RGB Bit system of embodiment 20, wherein the RGB Bit logic state comprises memory a lightness or a brightness.

Embodiment 35. The RGB Bit system of embodiment 20, wherein the RGB Bit logic state comprises memory chromatic and achromatic colors and states.

Embodiment 36. The RGB Bit system of embodiment 20, wherein the RGB Bit logic state memory radians.

Embodiment 37. The RGB Bit system of embodiment 20, wherein the RGB Bit logic state comprises RGB Bit memory vibrational vector equilibriums.

Embodiment 38. The RGB Bit system of embodiment 20, wherein the RGB Bit logic state comprises RGB Bit memory color filters, a photographic filter that absorbs light of certain colors.

Embodiment 39. The RGB Bit system of embodiment 20, wherein the RGB Bit logic state memory comprises prisms with refracting faceted geometric lenses at angles with each other that separates light into a spectrum of RGB Bit colors.

Embodiment 40. The RGB Bit system of embodiment 20, wherein the RGB Bit logic state RGB Bit analog and RGB Bit digital magnetic states determined by odd and even mathematical magnetic memory functions.

Embodiment 41. The RGB Bit system of embodiment 20, wherein the RGB Bit logic state comprises variable memory values.

Embodiment 42. The RGB Bit system of embodiment 1, wherein the RGB Bit memory circuitry comprises a memory magnet, a material or object that produces a magnetic field.

Embodiment 43. The RGB Bit system of embodiment 1, wherein the RGB Bit memory circuitry comprises a memory magnetic hysteresis loop.

Embodiment 44. The RGB Bit system of embodiment 1, wherein the RGB Bit memory circuitry comprises circuitry configured to determine a magnetic spectral state based on loop logic and spectral logic associated with RGB Bit hysteresis magnetic domains.

Embodiment 45. The RGB Bit system of embodiment 1, wherein the RGB Bit memory circuitry comprises robotics, machines, especially one programmable by a computer, capable of carrying out multiple memory complex series of actions automatically.

Embodiment 46. The RGB Bit system of embodiment 1, wherein the RGB Bit memory circuitry comprises RGB Bit memory feedback loops used to control the output of electronic devices.

Embodiment 47. The RGB Bit system of embodiment 1, wherein the RGB Bit memory circuitry comprises one or more electromagnetic emitters forming part of an input RGB Bit logic state or an output RGB Bit logic state.

Embodiment 48. The RGB Bit system of embodiment 1, wherein the RGB Bit memory circuitry includes one or more light-emitting diodes, laser diodes, microcavity light-emitting diodes, organic light-emitting diodes, polymer light-emitting diodes, polymer phosphorescent light-emitting diodes, or high-efficiency light-emitting diodes forming part of an input RGB Bit logic state or an output RGB Bit logic state.

Embodiment 49. The RGB Bit system of embodiment 1, wherein the RGB Bit memory circuitry includes one or more arc flashlamps, continuous wave bulbs, or incandescent emitters forming part of an input RGB Bit logic state or an output RGB Bit logic state.

Embodiment 50. The RGB Bit system of embodiment 1, wherein the RGB Bit memory circuitry includes one or more fiber lasers, lasers, or ultra-fast lasers forming part of an input/output RGB Bit logic state or an output RGB Bit logic state.

Embodiment 51. The RGB Bit system of embodiment 1, wherein the RGB Bit memory circuitry includes one or more quantum dots, electromagnetic energy emitters and receivers, electro-optical transducers, optical energy emitters, or optical fiber emitters forming part of an input RGB Bit logic state or an output RGB Bit logic state.

Embodiment 52. The RGB Bit system of embodiment 1, wherein the RGB Bit memory circuitry includes a photo electric sensor configured to emit light from a transmitter and to detect the light reflected from an object with a receiver, prism, reflected light capture component, reflective chamber, or holographic chamber.

Embodiment 53. The RGB Bit system of embodiment 1, wherein the RGB Bit memory circuitry includes a programmable light to frequency converter and inverter.

Embodiment 54. The RGB Bit system of embodiment 1, wherein the RGB Bit memory circuitry includes a configurable silicon photodiode and a current, voltage, or resistivity to frequency converter.

Embodiment 55. The RGB Bit system of embodiment 1, wherein the RGB Bit memory circuitry includes a monolithic complementary metal-oxide-semiconductor (CMOS) integrated circuit having a configurable silicon photodiode and a current to frequency converter.

Embodiment 56. The RGB Bit system of embodiment 1, wherein the RGB Bit memory circuitry is operably coupled to an RGB Bit clock controller configured to regulate at least on of an RGB Bit timing process, RGB bit spacing process, and RGB Bit speed process associated with a plurality of RGB Bit computations.

Embodiment 57. The RGB Bit system of embodiment 1, wherein the RGB Bit memory circuitry is configured to change a color to a preprogrammed color geometric grid responsive to one or more inputs/outputs indicative of a color and magnetic change.

Embodiment 58. The RGB Bit system of embodiment 1, wherein the RGB Bit memory circuitry includes one or more RGB Bit magnetic impulse emitters and receivers forming part of an RGB Bit combining magnetic state pixel arrays.

Embodiment 59. The RGB Bit system of embodiment 1, wherein the RGB Bit memory circuitry includes one or more light-emitting diodes, laser diodes, microcavity light-emitting diodes, organic light-emitting diodes, polymer light-emitting diodes, polymer phosphorescent light-emitting diodes, or high-efficiency light-emitting diodes forming part of an RGB Bit pixel array.

Embodiment 60. The RGB Bit system of embodiment 1, wherein the RGB Bit memory circuitry is configured to change an RGB Bit pixel array from a first pixelated color distribution to a second pixelated magnetic emulated color distribution, different from the first.

Embodiment 61. The RGB Bit system of embodiment 1, wherein the RGB Bit CPU includes circuitry configured to compute RGB Bit logic responsive to integration of at least one RGB Bit and determine a magnetic state associated with the at least one RGB Bit.

Embodiment 62. The RGB Bit system of embodiment 1, wherein the RGB Bit CPU includes circuitry configured to generate an RGB Bit color representation responsive to one or more inputs or outputs indicative of a positive state, neutral state, or a negative state.

Embodiment 63. The RGB Bit system of embodiment 1, further comprising: an RGB Bit (Red, Green, and Blue) Optical Coupler.

Embodiment 64. An RGB Bit (Red, Green, and Blue) system, comprising: an RGB Bit Central Processing Unit (CPU).

Embodiment 65. The RGB Bit system of embodiment 64, wherein the RGB Bit CPU includes circuitry configured to compute RGB Bit logic responsive to integration of at least one RGB Bit and determine a magnetic state associated with at least one RGB Bit.

Embodiment 66. The RGB Bit system of embodiment 64, wherein the RGB Bit CPU includes circuitry configured to generate an RGB Bit color representation responsive to one or more inputs or outputs indicative of a positive state, neutral state, or a negative state.

Embodiment 67. The RGB Bit system of embodiment 64, wherein the RGB Bit CPU is operably coupled to RGB Bit memory circuitry and is configured to compute RGB Bit logic.

Embodiment 68. The RGB Bit system of embodiment 64, further comprising: an RGB (Red, Green, and Blue) Bit generator configured to generate RGB Bit information.

Embodiment 69. The RGB Bit system of embodiment 68, further comprising: an RGB Bit memory circuitry configured to store the RGB Bit information.

Embodiment 70. The RGB Bit system of embodiment 69, wherein the RGB Bit memory circuitry comprises a memory magnet, a material or object that produces a magnetic field.

Embodiment 71. The RGB Bit system of embodiment 69, wherein the RGB Bit memory circuitry comprises a memory magnetic hysteresis loop configured to maintain a dependence of a state of a system on its history.

Embodiment 72. The RGB Bit system of embodiment 69, wherein the RGB Bit memory circuitry comprises circuitry configured to determine a magnetic spectral state based on loop logic and spectral logic associated with RGB Bit hysteresis magnetic domains.

Embodiment 73. The RGB Bit system of embodiment 69, wherein the RGB Bit memory circuitry comprises robotics, machines, especially one programmable by a computer, capable of carrying out multiple memory complex series of actions automatically.

Embodiment 74. The RGB Bit system of embodiment 69, wherein the RGB Bit memory circuitry comprises RGB Bit memory feedback loops used to control the output of electronic devices.

Embodiment 75. The RGB Bit system of embodiment 69, wherein the RGB Bit memory circuitry comprises one or more electromagnetic emitters forming part of an input RGB Bit logic state or an output RGB Bit logic state.

Embodiment 76. The RGB Bit system of embodiment 69, wherein the RGB Bit memory circuitry includes one or more light-emitting diodes, laser diodes, microcavity light-emitting diodes, organic light-emitting diodes, polymer light-emitting diodes, polymer phosphorescent light-emitting diodes, or high-efficiency light-emitting diodes forming part of an input RGB Bit logic state or an output RGB Bit logic state.

Embodiment 77. The RGB Bit system of embodiment 69, wherein the RGB Bit memory circuitry includes one or more arc flashlamps, continuous wave bulbs, or incandescent emitters forming part of an input RGB Bit logic state or an output RGB Bit logic state.

Embodiment 78. The RGB Bit system of embodiment 69, wherein the RGB Bit memory circuitry includes one or more fiber lasers, lasers, or ultra-fast lasers forming part of an input/output RGB Bit logic state or an output RGB Bit logic state.

Embodiment 79. The RGB Bit system of embodiment 69, wherein the RGB Bit memory circuitry includes one or more quantum dots, electromagnetic energy emitters and receivers, electro-optical transducers, optical energy emitters, optical fiber emitters forming part of an input RGB Bit logic state or an output RGB Bit logic state.

Embodiment 80. The RGB Bit system of embodiment 69, wherein the RGB Bit memory circuitry includes a photo electric sensor configured to emit light from a transmitter and to detect the light reflected from a detection object with a receiver, prism, reflected light capture component, reflective chamber, or holographic chamber.

Embodiment 81. The RGB Bit system of embodiment 69, wherein the RGB Bit memory circuitry includes a programmable light to frequency converter and inverter.

Embodiment 82. The RGB Bit system of embodiment 69, wherein the RGB Bit memory circuitry includes a configurable silicon photodiode and a current, voltage or resistivity to frequency converter.

Embodiment 83. The RGB Bit system of embodiment 69, wherein the RGB Bit memory circuitry includes a monolithic complementary metal-oxide-semiconductor (CMOS) integrated circuit having a configurable silicon photodiode and a current to frequency converter.

Embodiment 84. The RGB Bit system of embodiment 69, wherein the RGB Bit memory circuitry configured to change a color to a preprogrammed color geometric grid responsive to one or more inputs/outputs indicative of a color and magnetic change.

Embodiment 85. The RGB Bit system of embodiment 69, wherein the RGB Bit memory circuitry includes one or more RGB Bit magnetic impulse emitters and receivers forming part of an RGB Bit combining magnetic state pixel array.

Embodiment 86. The RGB Bit system of embodiment 69, wherein the RGB Bit memory circuitry includes one or more light-emitting diodes, laser diodes, microcavity light-emitting diodes, organic light-emitting diodes, polymer light-emitting diodes, polymer phosphorescent light-emitting diodes, or high-efficiency light-emitting diodes forming part of an RGB Bit pixel array.

Embodiment 87. The RGB Bit system of embodiment 69, wherein the RGB Bit memory circuitry is configured to change an RGB Bit pixel array from a first pixelated color distribution to a second pixelated magnetic emulated color distribution, different from the first.

Embodiment 88. The RGB Bit system of embodiment 69, further comprising:
an RGB Bit clock controller configured to regulate at least one of an RGB Bit timing process, RGB bit spacing process, and RGB Bit speed process associated with a plurality of RGB Bit computations.

Embodiment 89. The RGB Bit system of embodiment 69, further comprising: an RGB (Red, Green, and Blue) Optical Coupler.

Embodiment 90. A method, comprising:
generating RGB (Red, Green, and Blue) Bit representation;
detecting and storing the RGB Bit representation; and
determining an input RGB Bit logic state or an output RGB Bit logic state responsive to detecting and
storing the RGB Bit representation.

Embodiment 91. The method of embodiment 90, wherein generating the RGB Bit representation includes emitting or receiving an optical and magnetic signal forming part of an RGB Bit.

Embodiment 92. The method of embodiment 90, wherein generating the RGB Bit representation includes detecting an optical and magnetic signal from an electromagnetic emitter/receiver array and generating the RGB Bit representation.

Embodiment 93. The method of embodiment 90, wherein detecting and storing the RGB Bit representation includes addressing the RGB Bit representation.

Embodiment 94. The method of embodiment 90, wherein generating the RGB Bit representation includes generating individual RGB bits using colors and magnetic states.

Embodiment 95. The method of embodiment 90, wherein generating the RGB Bit representation includes generating an RGB Bit color representation responsive to one or more inputs indicative of a positive state, a neutral state, or a negative state.

Embodiment 96. An RGB (Red, Green, Blue) Bit logic computation system, comprising:
means for generating RGB Bit information;
means for storing the RGB Bit information; and
means for computing using RGB Bit logic.

Embodiment 97. The RGB Bit Logic Computation System of embodiment 96, wherein the means for generating RGB Bit information comprises a CPU containing processing circuitry including an RGB Bit Generator configured to generate a magnetic spectral color signal clocking that is subdivided to form part of one or more RGB Bit logic states.

Embodiment 98. The RGB Bit Logic Computation System of embodiment 96, wherein the means for generating RGB Bit information comprises processing circuitry configured to magnetic states including a polarity responsive to one or more inputs indicative of RGB Bit logic computation.

Embodiment 99. The RGB Bit Logic Computation System of embodiment 96, wherein the means for storing the RGB Bit information comprises a CPU configured to generate, read, write, and store an RGB Bit logic state.

Embodiment 100. The RGB Bit Logic Computation System of embodiment 96, wherein the means for storing the RGB Bit information CPU comprises a memory circuitry including one or more light-emitting diodes, laser diodes, microcavity light-emitting diodes, organic light-emitting diodes, polymer light-emitting diodes, polymer phosphorescent light-emitting diodes, or high-efficiency light-emitting diodes forming part of an input RGB Bit logic state or an output RGB Bit logic state.

Embodiment 101. The RGB Bit Logic Computation System of embodiment 96, wherein the means for storing the RGB Bit CPU information comprises one or more fiber lasers, lasers, or ultra-fast lasers forming part of an input/output RGB Bit logic state or an output RGB Bit logic state.

Embodiment 102. The RGB Bit Logic Computation System of embodiment 96, wherein the means for storing the RGB Bit CPU information comprises an RGB Bit color light or magnetic sensor timing clocking function identifying it as its own RGB Bit magnetic spectral memory state.

Embodiment 103. The RGB Bit Logic Computation System of embodiment 96, wherein the means for storing the RGB Bit CPU information comprises a processor couple to an RGB Bit memory circuitry configured to change a color to a preprogrammed color geometric grid responsive to one or more inputs/outputs indicative of a color and magnetic change.

Embodiment 104. The RGB Bit Logic Computation System of embodiment 96, wherein the means for storing the RGB Bit CPU information comprises a processor couple to an RGB Bit memory circuitry is configured to change an RGB Bit pixel array from a first pixelated color distribution to a second pixelated magnetic emulated color distribution, different from the first.

Embodiment 105. The RGB Bit Logic Computation System of embodiment 96, wherein the means for computing using RGB Bit CPU logic comprises an RGB Bit Central Processing Unit (CPU) including circuitry configured to compute RGB Bit logic responsive to integration of at least one RGB Bit and determine a magnetic state associated with at least one RGB Bit.

Embodiment 106. The RGB Bit Logic Computation System of embodiment 96, wherein the means for computing using RGB Bit CPU logic comprises an RGB Bit CPU including circuitry configured to generate an RGB Bit color representation responsive to one or more inputs or outputs indicative of a positive state, neutral state, or a negative state.

Embodiment 107. A system, comprising:
an RGB Bit (Red, Green, and Blue) Optical Coupler;
an RGB Bit (Red, Green, and Blue) generator configured to generate RGB Bit information;
an RGB Bit memory circuitry configured to store the RGB Bit information; and
an RGB Bit Central Processing Unit (CPU) operably coupled to the RGB Bit memory circuitry, the RGB Bit CPU and CPU configured to compute RGB Bit logic.

What is claimed is:

1. A system, comprising:
processing circuitry configured to
store a predetermined mapping of separate pieces of bit information and data symbols in a first format, each piece of bit information defining a bit and including (i) at least a color that is based one or more of at least two different colors or (ii) at least one of a plurality of magnetic states; and
receive data symbols in the first format and output bits based on the stored predetermined mapping.

2. The system according to claim 1,
wherein the predetermined mapping of separate pieces of bit information is a predetermined mapping of separate pieces of RGB (red, green, and blue) Bit information and data symbols in the first format, each piece of RGB it information defining an RGB Bit and including at least a color that is a based on red, green, or blue color values; and
the processing circuitry is configured to receive data symbols in the first format and output consecutive RGB Bits based on the stored predetermined mapping.

3. The system according to claim 2, wherein the processing circuitry is configured to store the predetermined mapping of separate pieces of RGB Bit information and data symbols in a binary data format, and wherein the data symbols are binary data having a predetermined bit length that can be represented by a single RGB Bit.

4. The system according to claim 3, wherein each piece of RGB Bit information further includes polarity information that represents a position of the respective RGB Bit with respect to an origin in space.

5. The system according to claim 4, wherein each piece of RGB Bit information further includes phase information that represents a position of the respective RGB Bit in time.

6. The system according to claim 2, wherein the red, green, or blue color values is a sequence of color segments each being red, green, or blue.

7. The system according to claim 2, wherein the red, green, or blue color values is a single color that represents a blended combination of either red, green, or blue.

8. The system according to claim 7, wherein the single color for the RGB Bit simultaneously conveys (i) binary data having a predetermined bit length, (ii) polarity information that represents a position of the respective RGB Bit with respect to an origin in space, and (iii) phase information that represents a position of the respective RGB Bit in time.

9. The system according to claim 1, wherein each RGB Bit represents a position on a magnetic hysteresis loop where each position is a positive or negative state of flux density or magnetizing force.

10. A system, comprising:
processing circuitry configured to
receive separate pieces of bit information and data symbols in a first format, each piece of bit information defining a bit and including at least a color that is based one or more of at least two different colors; and
control an output of the bits as a physical change or oscillation of an element in time and space.

11. The system according to claim 10,
wherein the separate pieces of bit information are separate pieces of RGB (red, green, and blue) Bit information, each piece of RGB Bit information defining an RGB Bit and including at least a color that is a based on a red, green, or blue color values; and
the processing circuitry is configured to control output of the RGB Bits as emissions of color in time and space.

12. The system according to claim 11, further comprising:
at least one light source configured to output emissions of any of red, green, and blue color values.

13. The system according to claim 12, wherein the red, green, or blue color values is a single color that represents a blended combination of either red, green, or blue, the single color for the RGB Bit simultaneously conveys polarity information that represents a position of the respective RGB Bit with respect to an origin in space, and the phase information that represents a position of the respective RGB Bit in time,
wherein the at least one light source is configured to control emission of the RGB Bits based on the polarity information and the phase information.

14. The system according to claim 13, wherein the at least one light source includes at least two of a red light emitter, a green light emitter, and a blue light emitter that are configured to emit, in a two-dimensional plane, separate circles of red, green or blue light that intersect at the origin and multiple locations representing combinations of two of red, green, and blue, wherein the emission by the at least two of the red light emitter, the green light emitter, and the blue light emitter in the temporal plane is sinusoidal with different phases, and the processing circuitry is configured to modulate emission of the at least two of the red light emitter, a green light emitter, and a blue light emitter to convey the RGB Bits at separate instances of time.

15. The system according to claim 14, wherein the at least two of the red light emitter, a green light emitter, and a blue light emitter are generated by a display screen that includes an array of pixels.

16. The system according to claim 14, wherein the at least two of the red light emitter, a green light emitter, and a blue light emitter are generated by mechanically rotating the at least two of the red light emitter, the green light emitter, and the blue light emitter in space.

17. The system according to claim 13, wherein at least one light source is an optical coupler.

18. A system, comprising:
an RGB (Red, Green, and Blue) Bit generator configured to generate RGB Bit information;
an RGB (Red, Green, and Blue) Bit memory circuitry configured to store the RGB Bit information; and
an RGB (Red, Green, and Blue) Bit Central Processing Unit (CPU) operably coupled to the RGB Bit memory circuitry, and the RGB Bit CPU and is configured to compute RGB Bit logic.

19. The RGB Bit system of claim 18, wherein the RGB Bit generator includes circuitry configured to generate RGB Bit information including a magnetic state.

20. The RGB Bit system of claim 19, wherein the magnetic state comprises polarity: at least two of a positive state, a neutral state, and a negative state including both odd and even magnetic polarity configurations.

21. The RGB Bit system of claim 18, wherein the RGB Bit generator includes circuitry configured to determine an RGB Bit magnetic spectral state based on feedback loop logic and spectral logic associated with RGB Bit hysteresis magnetic domains.

22. The RGB Bit system of claim 18, wherein the RGB Bit generator comprises a programmable variable impulse generator including circuitry configured to perform at least one of generating magnetic spectral color signal clocking, generating RGB Bit most significant bit and least significant bit information, inverting alternating color magnetic spectral signals, and rotating temporal variational vibrational states.

23. The RGB Bit system of claim 18, wherein the RGB Bit memory circuitry includes memory circuitry configured to generate, read, write, and store an RGB Bit logic state: wherein the RGB Bit logic state comprises RGB Bit spectral memory radians hue saturation values. Hue is assigning spectral rotation. Saturation is the amplitude of the signal. The RGB Bit system of claim 5, wherein the RGB Bit logic state comprises memory lightness and brightness, a visual perception of the luminance of an object. Lightness is a prediction of how an illuminated color will appear.

24. The RGB Bit system of claim 18, wherein the RGB Bit memory circuitry configured to change a color to a preprogrammed color geometric grid responsive to one or more inputs/outputs indicative of a color and magnetic change.

25. The RGB Bit system of claim 18, wherein the RGB Bit memory circuitry is configured to change an RGB Bit pixel array from a first pixelated color distribution to a second pixelated magnetic emulated color distribution, different from the first.

26. The RGB Bit system of claim 18, wherein the RGB Bit memory circuitry includes one or more light-emitting diodes, laser diodes, microcavity light-emitting diodes, organic light-emitting diodes, polymer light-emitting diodes, polymer phosphorescent light-emitting diodes, high-efficiency light-emitting diodes, more quantum dots, electro-optical transducers, optical energy emitters, or optical fiber emitters forming part of an input RGB Bit logic state, an output RGB Bit logic state or an RGB Bit pixel array.

27. The RGB Bit system of claim 18, wherein the RGB Bit memory circuitry is operably coupled to an RGB Bit clock controller configured to regulate at least one of an RGB Bit timing process, RGB Bit spacing process, and RGB Bit speed process associated with a plurality of RGB Bit computations.

28. The RGB Bit system of claim 18, wherein the RGB Bit CPU includes circuitry configured to generate an RGB Bit color representation responsive to one or more inputs or outputs indicative of a positive state, neutral state, or a negative state.

29. The RGB Bit system of claim 18, wherein the RGB Bit CPU includes circuitry configured to compute RGB Bit logic responsive to integration of at least one RGB Bit and determine a magnetic state associated with at least one RGB Bit.

30. The RGB Bit system of claim 18, further comprising: an RGB Bit (Red, Green, and Blue) Optical Coupler.

31. The RGB Bit system of claim 18, further comprising: an RGB Bit clock controller configured to regulate at least one of an RGB Bit timing process, RGB Bit spacing process, and RGB Bit speed process associated with a plurality of RGB Bit computations.
